(19) United States
(12) Patent Application Publication
(10) Pub. No.: US 2025/0200431 A1
(43) Pub. Date: Jun. 19, 2025

(54) INFERENCE DATA DISTRIBUTION CRITERIA FOR ARTIFICIAL INTELLIGENCE OR MACHINE LEARNING MODEL MONITORING

(71) Applicant: QUALCOMM Incorporated, San Diego, CA (US)

(72) Inventors: Mohamed Fouad Ahmed MARZBAN, San Diego, CA (US); Tao LUO, San Diego, CA (US); Wooseok NAM, San Diego, CA (US)

(21) Appl. No.: 18/544,782

(22) Filed: Dec. 19, 2023

(51) Int. Cl. G06N 20/00; H04L 41/16; H04W 24/08

(52) U.S. Cl. CPC G06N 20/00; H04L 41/16; H04W 24/08

(57) ABSTRACT

Various aspects of the present disclosure generally relate to wireless communication. In some aspects, a network entity may receive one or more criteria for an artificial intelligence or machine learning (AI/ML) model monitoring operation. The network entity may perform, for an AI/ML model, the AI/ML model monitoring operation based on a first distribution of inference data associated with the AI/ML model satisfying the one or more criteria. The network entity may perform, for the AI/ML model, an action based on the AI/ML model monitoring operation. Numerous other aspects are described.

### FIELD OF THE DISCLOSURE

Aspects of the present disclosure generally relate to wireless communication and specifically relate to techniques, apparatuses, and methods associated with inference data distribution criteria for artificial intelligence or machine learning model monitoring.

### INTRODUCTION

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

In some aspects, a network entity for wireless communication includes a processing system configured to: receive one or more criteria for an artificial intelligence or machine learning (AI/ML) model monitoring operation; perform, for an AI/ML model, the AI/ML model monitoring operation based on a first distribution of inference data associated with the AI/ML model satisfying the one or more criteria; and perform, for the AI/ML model, an action based on the AI/ML model monitoring operation.

In some aspects, a method of wireless communication performed by a network entity includes receiving one or more criteria for an AI/ML model monitoring operation; performing, for an AI/ML model, the AI/ML model monitoring operation based on a first distribution of inference data associated with the AI/ML model satisfying the one or more criteria; and performing, for the AI/ML model, an action based on the AI/ML model monitoring operation.

In some aspects, a non-transitory computer-readable medium having instructions for wireless communication stored thereon that, when executed by a network entity, causes the network entity to: receive one or more criteria for an AI/ML model monitoring operation; perform, for an AI/ML model, the AI/ML model monitoring operation based on a first distribution of inference data associated with the AI/ML model satisfying the one or more criteria; and perform, for the AI/ML model, an action based on the AI/ML model monitoring operation.

In some aspects, an apparatus for wireless communication includes means for receiving one or more criteria for an AI/ML model monitoring operation; means for performing, for an AI/ML model, the AI/ML model monitoring operation based on a first distribution of inference data associated with the AI/ML model satisfying the one or more criteria; and means for performing, for the AI/ML model, an action based on the AI/ML model monitoring operation.

In some aspects, a first network entity for wireless communication includes a processing system configured to: transmit, for a second network entity, one or more criteria for inference data to be used for an AI/ML model monitoring operation for an AI/ML model deployed at the second network entity.

In some aspects, a method of wireless communication performed by a first network entity includes transmitting, for a second network entity, one or more criteria for inference data to be used for an AI/ML model monitoring operation for an AI/ML model deployed at the second network entity.

In some aspects, a non-transitory computer-readable medium having instructions for wireless communication stored thereon that, when executed by a first network entity, causes the first network entity to: transmit, for a second network entity, one or more criteria for inference data to be used for an AI/ML model monitoring operation for an AI/ML model deployed at the second network entity.

In some aspects, an apparatus for wireless communication includes means for transmitting, for a network entity, one or more criteria for inference data to be used for an AI/ML model monitoring operation for an AI/ML model deployed at the network entity.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing broadly outlines example features and example technical advantages of examples according to the disclosure. Additional example features and example advantages are described hereinafter.

### BRIEF DESCRIPTION OF THE DRAWINGS

The appended drawings illustrate certain example aspects of this disclosure and are therefore not limiting in scope. The same reference numbers in different drawings may identify the same or similar elements.

FIG. 1 is a diagram illustrating an example environment in which apparatuses and/or methods described herein may be implemented, in accordance with the present disclosure.

FIG. 2 is a diagram illustrating an example of a wireless communication network in accordance with the present disclosure.

FIG. 3 is a diagram illustrating an example network node in communication with an example user equipment (UE) in a wireless network in accordance with the present disclosure.

FIG. 4 is a diagram illustrating an example disaggregated base station architecture in accordance with the present disclosure.

FIG. 5 is a diagram illustrating an example architecture of a functional framework for radio access network intelligence enabled by data collection, in accordance with the present disclosure.

FIG. 6 is a diagram illustrating an example of data distribution of inference data and training data for artificial intelligence and/or machine learning (AI/ML) models, in accordance with the present disclosure.

FIG. 7 is a diagram of an example associated with inference data distribution criteria for AI/ML model monitoring, in accordance with the present disclosure.

FIG. 8 is a diagram of an example associated with inference data distribution criteria for AI/ML model monitoring, in accordance with the present disclosure.

FIG. 9 is a diagram of an example associated with timing criteria for an inference data distribution for AI/ML model monitoring, in accordance with the present disclosure.

FIG. 10 is a diagram of an example associated with timing criteria for an inference data distribution for AI/ML model monitoring, in accordance with the present disclosure.

FIG. 11 is a diagram illustrating an example process performed, for example, at a network entity or an apparatus of a network entity, in accordance with the present disclosure.

FIG. 12 is a diagram illustrating an example process performed, for example, at a first network entity or an apparatus of a first network entity, in accordance with the present disclosure.

FIG. 13 is a diagram of an example apparatus for wireless communication, in accordance with the present disclosure.

FIG. 14 is a diagram of an example apparatus for wireless communication, in accordance with the present disclosure.

### DETAILED DESCRIPTION

An entity (e.g., a model inference host) may collect inference data to be input to an artificial intelligence and/or machine learning (AI/ML) model. For example, the entity may be configured to use a first AI/ML model and a second AI/ML model for one or more operations, such as temporal beam predictions or another operation. The inference data may have an inference data distribution. An AI/ML model monitoring operation may include comparing the inference data distribution to a training data distribution for an AI/ML model (e.g., a distribution of data used to train the AI/ML model). For example, the entity may determine a similarity metric indicating a similarity or distance between different data distributions.

For example, an AI/ML model monitoring operation may include monitoring a similarity metric between the inference data distribution and the training data distribution for one or more AI/ML models. As an example, if the similarity metric for the inference data distribution and a training data distribution for a given AI/ML model satisfies a threshold, then the entity may continue to use the given AI/ML model or may switch to using the given AI/ML model. Alternatively, if the similarity metric for the inference data distribution and a training data distribution for a given AI/ML model does not satisfy the threshold, then the entity may refrain from performing AI/ML operations, may switch to using a different AI/ML model, and/or may perform online training of the given AI/ML model, among other examples.

There may be multiple factors that impact the properties and/or distributions of inference data and output(s) of an AI/ML model. For example, the factors may include signal-to-interference-plus-noise ratio (SINR) levels of an input reference signal used in training of the AI/ML model, a scheduling mode used by a network node (e.g., single user (SU) MIMO scheduling or multi-user (MU) MIMO scheduling), a reference signal type used to obtain the inference data or the training data, an energy per resource element (EPRE) of the reference signal, a change in operating conditions (e.g., a change in bandwidth, a frequency band, a beam, or another communication characteristic), a change in one or more communication parameters (e.g., a quantity of ports, a quantity of antenna panels, a quantity of antenna elements, and/or another communication parameter), and/or a change in operating environment (e.g., rural versus urban, high Doppler versus low Doppler, and/or high interference versus low interference), among other examples.

Therefore, because such factors may impact the performance of an AI/ML model, an entity may perform an AI/ML model monitoring operation (e.g., using data distributions) to detect data drifts and switch or finetune an AI/ML model being used by the entity (or another entity). For example, the entity may use statistical-based AI/ML model monitoring by comparing the inference data distribution with the training data distribution, as described in more detail elsewhere herein. However, the accuracy of data drift detections for an AI/ML model may be based on one or more properties of the inference data distribution. For example, if there are large gaps between measurements included in the inference data distribution, then the inference data distribution may not capture all aspects of the environment which may reduce the accuracy of data drift detection. As another example, if there are more samples (measurements) in the inference data distribution, then the inference data distribution may be more representative of the environment, which can increase the accuracy of data drift detection. However, increasing the quantity of samples (e.g., by increasing the monitoring period used to collect the inference data) in the inference data distribution may cause some measurements to become outdated. As a result, this may delay (or slow down) data drift detection for the AI/ML model.

Various aspects relate generally to inference data distribution criteria for AI/ML model monitoring. Some aspects more specifically relate to using one or more criteria to ensure that an inference data distribution is suitable to be used for an AI/ML model monitoring operation. In some aspects, a first network entity may transmit, and a second network entity may receive, one or more criteria for an AI/ML model monitoring operation. The second network entity may perform, for an AI/ML model, the AI/ML model monitoring operation based on an inference data distribution for the AI/ML model satisfying the one or more criteria. For example, if the inference data distribution has one or more properties as indicated (or defined) by the one or more criteria, then the second network entity may use the inference data distribution for the AI/ML model monitoring operation. The second network entity may perform, for the AI/ML model, an action based on a result of the AI/ML model monitoring operation.

In some aspects, the one or more criteria may include timing information, such as one or more time durations for the inference data distribution. In some aspects, the one or more criteria may include a quantity of measurement samples (e.g., a minimum quantity) to be included in the inference data distribution. In some aspects, the one or more criteria may include an allowable time gap between samples included in the inference data distribution. In some aspects, the one or more criteria may be based on, or otherwise associated with, one or more operating conditions of the second network entity.

Particular aspects of the subject matter described in this disclosure can be implemented to realize one or more of the following potential advantages. In some examples, the described techniques can be used to improve a likelihood that the inference data distribution used for the AI/ML model monitoring operation is representative of an environment in which the second network entity is operating. This improves data drift detections for the AI/ML model, thereby enabling the second network entity to quickly perform one or more corrective actions when data drift is detected, such as switching the AI/ML model, falling back to non-AI/ML operation, or retraining the AI/ML model, among other examples. In some aspects, by configuring the one or more criteria based on operating conditions (e.g., speed, Doppler information, or other operating conditions), the inference data distribution may be tailored to the operating conditions of the second network entity, thereby improving the accuracy of a result of the AI/ML model monitoring operation.

Various aspects of the disclosure are described more fully hereinafter with reference to the accompanying drawings. This disclosure may, however, be embodied in many different forms and is not limited to any specific structure, function, example, aspect, or the like presented throughout this disclosure. This disclosure includes, for example, any aspect disclosed herein, whether implemented independently of or combined with any other aspect of the disclosure. For example, an apparatus may be implemented or a method may be practiced using any number of the aspects set forth herein. In addition, the scope of the disclosure includes such an apparatus or method which is practiced using other structure, functionality, or structure and functionality in addition to or other than the various aspects of the disclosure set forth herein. Any aspect of the disclosure disclosed herein may be embodied by one or more elements of a claim.

Aspects and examples generally include a method, apparatus, network node, network entity, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the example concepts disclosed herein, both their organization and method of operation, together with associated example advantages, are described in the following description and in connection with the accompanying figures. Each of the figures is provided for the purposes of illustration and description, and not as a definition of the limits of the claims. Each of the figures is provided for the purposes of illustration and description, and not as a definition of the limits of the claims.

While aspects are described in the present disclosure by illustration to some examples, those skilled in the art understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described example aspects and example features may include additional example components and example features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems are presented with reference to various apparatuses and techniques. These apparatuses and techniques are described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

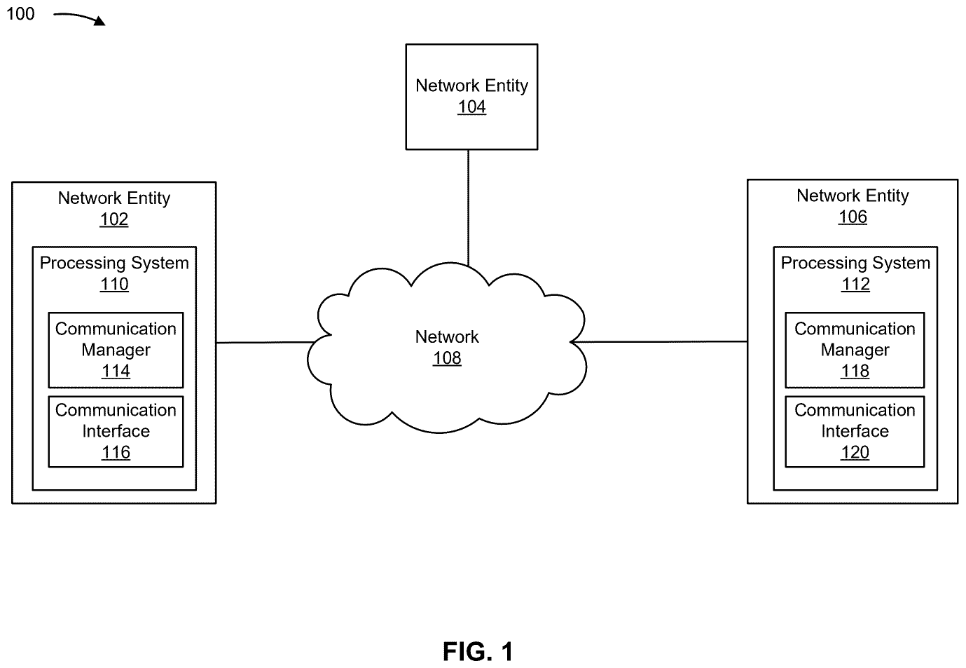

FIG. 1 is a diagram illustrating an example environment 100 in which apparatuses and/or methods described herein may be implemented, in accordance with the present disclosure. As shown in FIG. 1, the environment 100 may include a network entity 102, a network entity 104, and a network entity 106, that may communicate with one another via a network 108. The network entities 102, 104, and 106, may be dispersed throughout the network 108, and each network entity 102, 104, and 106 may be stationary and/or mobile. The network 108 may include wired communication connections, wireless communication connections, or a combination of wired and wireless communication connections.

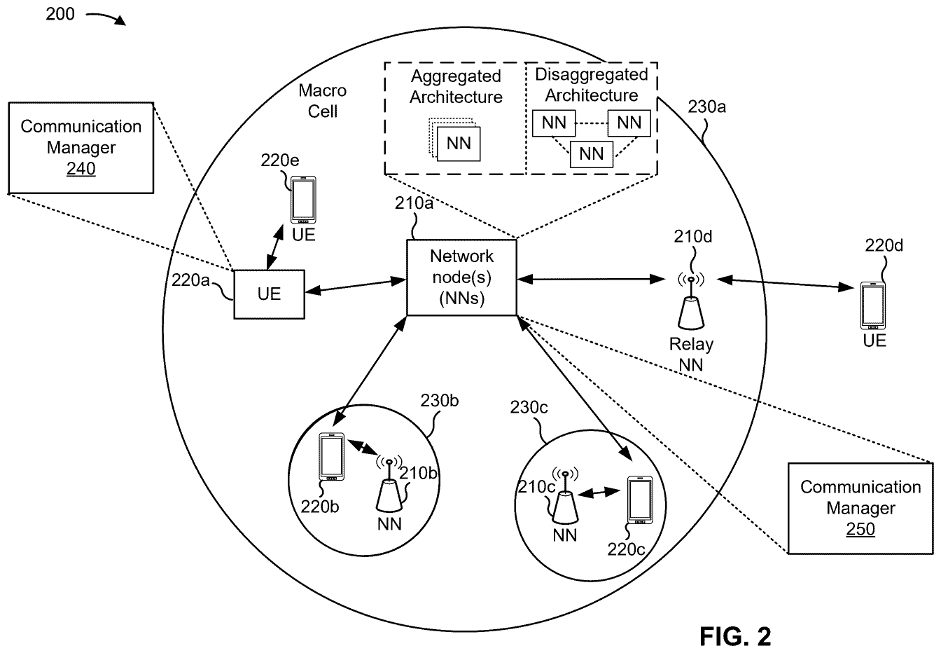

The network 108 may include, for example, a cellular network (e.g., a Long-Term Evolution (LTE) network, a code division multiple access (CDMA) network, a 4G network, a 5G network, a 6G network, or another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks. The network 108 may include a wireless communication network 200, described in connection with FIG. 2.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network 108. For example, a “network entity” is not limited to an entity that is currently located in and/or currently operating in the network. Rather, a network entity may be any entity that is capable of communicating and/or operating in the network. A network entity may include a network node 210 or a UE 220, described in more detail in connection with FIG. 2.

The adjectives “first,” “second,” “third,” and so on are used for contextual distinction between two or more of the modified nouns in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., disclosure of a UE configured to receive information from a base station also discloses that a first network entity is configured to receive information from a second network entity), the broader example of the narrower example may be interpreted in the reverse, but in a broad open-ended way. In the example above where a disclosure of a UE configured to receive information from a base station also discloses that a first network entity is configured to receive information from a second network entity, “first network entity” may refer to a first UE, a first base station, a first apparatus, a first device, a first computing system, a first set of one or more one or more components, a first processing entity, or the like configured to receive the information; and “second network entity” may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity 102 may include a processing system 110. Similarly, the network entity 106 may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof.

As described herein, “input” and “input information” may be used interchangeably. Similarly, as described herein, “output” and “output information” may be used interchangeably. Any information generated by any component may be provided to one or more other systems or components of, for example, a network entity described herein. For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

For example, as shown in FIG. 1, the processing system 110 may include a (e.g., one or more) communication manager 114 and one or more communication interfaces 116. The communication manager 114 may be configured to perform one or more communication tasks as described herein. In some aspects, the communication manager 114 may direct the communication interface 120 and/or the processing system 110 to perform one or more communication tasks as described herein. Similarly, the processing system 112 may include a (e.g., one or more) communication manager 118 and one or more communication interfaces 120. The communication manager 118 may be configured to perform one or more communication tasks as described herein. In some aspects, the processing system 112 and/or the communication manager 118 may direct the communication interface 120 to perform one or more communication tasks as described herein. Although depicted, for clarity of description, with reference only to the network entities 102 and 104, any one or more of the network entities 102, 104, and 106 also may include a communication manager and a communication interface.

As used herein, “communication interface” refers to an interface that enables communication (e.g., wireless communication, wired communication, or a combination thereof) between a first network entity and a second network entity. A communication interface may include electronic circuitry that enables a network entity to transmit, receive, or otherwise perform the communication. A communication interface may be, be similar to, include, or be included in one or more components that are configured to enable communication between the first network entity and the second network entity. For example, a communication interface may include a transmission component, a reception component, and/or a transceiver, among other examples. For example, a communication interface may include one or more transceivers, one or more receivers, and/or one or more transmitters configured to communicate with other devices, such as via a wired connection, a wireless connection, or a combination of wired and wireless connections. In some examples, a communication interface may include one or more RF components, an RF front end, one or more antennas, one or more transmit or receive processors, a demodulation component, and/or a modulation component, among other examples.

A communication interface may include a transmission component and/or a reception component. For example, a communication interface may include a transceiver and/or one or more separate receivers and/or transmitters that enable a network entity to communicate with other devices, such as via a wired connection, a wireless connection, or a combination of wired and wireless connections. In some examples, a communication interface may include one or more radio frequency reflective elements and/or one or more radio frequency refractive elements. The communication interface may enable the network entity to receive information from another apparatus and/or provide information to another apparatus. In some examples, the communication interface may include an Ethernet interface, an optical interface, a coaxial interface, an infrared interface, an RF interface, a universal serial bus (USB) interface, a Wi-Fi interface, a cellular network interface, a wireless modem, an inter-integrated circuit (I2C), and/or a serial peripheral interface (SPI), among other examples.

As described herein, a network entity (e.g., the network entity 102 and/or the network entity 106) may be configured to perform one or more operations. Reference to a network entity being configured to perform one or more operations may refer to a processing system of the network entity being configured to perform the one or more operations and/or the processing system being configured to cause one or more components of the network entity to perform the one or more operations. For example, reference to the processing system being configured to perform one or more operations may refer to one or more components (or subcomponents) of the processing system performing the one or more operations. For example, the one or more components of the processing system may include at least one memory, at least one processor, and/or at least one communication interface, among other examples, that are configured to perform one or more (or all) of the one or more operations, and/or any combination thereof. Where reference is made to the network entity and/or the processing system being configured to perform operations, the network entity and/or the processing system may be configured to cause one component to perform all operations, or to cause more than one component to collectively perform the operations. When the network entity and/or the processing system is configured to cause more than one component to collectively perform the operations, each operation need not be performed by each of those components (e.g., different operations may be performed by different components) and/or each operation need not be performed in whole by only one component (e.g., different components may perform different sub-functions of an operation).

As described in more detail elsewhere herein, the network entity 102 may (e.g., the processing system 110 may, or the processing system 110 may cause the communication manager 114 and/or the communication interface 116 to) receive one or more criteria for an AI/ML model monitoring operation; perform, for an AI/ML model, the AI/ML model monitoring operation based on a first distribution of inference data associated with the AI/ML model satisfying the one or more criteria; and/or perform, for the AI/ML model, an action based on the AI/ML model monitoring operation. Additionally, or alternatively, the network entity 102 and/or the communication manager 114 may perform one or more other operations described herein.

As described in more detail elsewhere herein, the network entity 106 may (e.g., the processing system 112 may, or the processing system 112 may cause the communication manager 114 and/or the communication interface 116 to) transmit, for a second network entity, one or more criteria for inference data to be used for an AI/ML model monitoring operation for an AI/ML model deployed at the second network entity. Additionally, or alternatively, the network entity 106 and/or the communication manager 118 may perform one or more other operations described herein.

The number and arrangement of entities shown in FIG. 1 are provided as one or more examples. In practice, there may be additional network entities and/or networks, fewer network entities and/or networks, different network entities and/or networks, or differently arranged network entities and/or networks than those shown in FIG. 1. Furthermore, the network entity 102, 104, and 106 may be implemented using a single apparatus or multiple apparatuses.

FIG. 2 is a diagram illustrating an example of a wireless communication network 200 in accordance with the present disclosure. The wireless communication network 200 may be or may include elements of a 5G (or NR) network or a 6G network, among other examples. The wireless communication network 200 may include multiple network nodes 210, shown as a network node (NN) 210a, a network node 210b, a network node 210c, and a network node 210d. The network nodes 210 may support communications with multiple UEs 220, shown as a UE 220a, a UE 220b, a UE 220c, a UE 220d, and a UE 220c.

The network nodes 210 and the UEs 220 of the wireless communication network 200 may communicate using the electromagnetic spectrum, which may be subdivided by frequency or wavelength into various classes, bands, carriers, and/or channels. For example, devices of the wireless communication network 200 may communicate using one or more operating bands. In some aspects, multiple wireless communication networks 200 may be deployed in a given geographic area. Each wireless communication network 200 may support a particular radio access technology (RAT) (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHz), FR4a or FR4-1 (52.6 GHz through 71 GHZ), FR4 (52.6 GHz through 114.25 GHZ), and FR5 (114.25 GHz through 300 GHz). Although a portion of FR1 is greater than 6 GHZ, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1. FR4, and FR5 falls within the EHF band. In some examples, the wireless communication network 200 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 210 may include one or more devices, components, or systems that enable communication between a UE 220 and one or more devices, components, or systems of the wireless communication network 200. A network node 210 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 210 may be implemented as a single physical node (for example, a single physical structure) or may be implemented as two or more physical nodes (for example, two or more distinct physical structures). For example, a network node 210 may be a device or system that implements part of a radio protocol stack, a device or system that implements a full radio protocol stack (such as a full gNB protocol stack), or a collection of devices or systems that collectively implement the full radio protocol stack. For example, and as shown, a network node 210 may be an aggregated network node (having an aggregated architecture), meaning that the network node 210 may implement a full radio protocol stack that is physically and logically integrated within a single node (for example, a single physical structure) in the wireless communication network 200. For example, an aggregated network node 210 may consist of a single standalone base station or a single TRP that uses a full radio protocol stack to enable or facilitate communication between a UE 220 and a core network of the wireless communication network 200.

Alternatively, and as also shown, a network node 210 may be a disaggregated network node (sometimes referred to as a disaggregated base station), meaning that the network node 210 may implement a radio protocol stack that is physically distributed and/or logically distributed among two or more nodes in the same geographic location or in different geographic locations. For example, a disaggregated network node may have a disaggregated architecture. In some deployments, disaggregated network nodes 210 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 210 of the wireless communication network 200 may include one or more central units (CUs), one or more distributed units (DUs), and/or one or more radio units (RUS). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (IFFT), beamforming, physical random access channel (PRACH) extraction and filtering, and/or scheduling of resources for one or more UEs 220, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 220.

In some aspects, a single network node 210 may include a combination of one or more CUs, one or more DUs, and/or one or more RUs. Additionally or alternatively, a network node 210 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 210 (for example, a base station, an RU, or a TRP) may provide communication coverage for a particular geographic area. In the 3GPP, the term “cell” can refer to a coverage area of a network node 210 or to a network node 210 itself, depending on the context in which the term is used. A network node 210 may support one or multiple (for example, three) cells. In some examples, a network node 210 may provide communication coverage for a macro cell, a pico cell, a femto cell, or another type of cell. A macro cell may cover a relatively large geographic area (for example, several kilometers in radius) and may allow unrestricted access by UEs 220 with service subscriptions. A pico cell may cover a relatively small geographic area and may allow unrestricted access by UEs 220 with service subscriptions. A femto cell may cover a relatively small geographic area (for example, a home) and may allow restricted access by UEs 220 having association with the femto cell (for example, UEs 220 in a closed subscriber group (CSG)). A network node 210 for a macro cell may be referred to as a macro network node. A network node 210 for a pico cell may be referred to as a pico network node. A network node 210 for a femto cell may be referred to as a femto network node or an in-home network node. In some examples, a cell may not necessarily be stationary. For example, the geographic area of the cell may move according to the location of an associated mobile network node 210 (for example, a train, a satellite base station, an unmanned aerial vehicle, or a non-terrestrial network (NTN) network node).

The wireless communication network 200 may be a heterogeneous network that includes network nodes 210 of different types, such as macro network nodes, pico network nodes, femto network nodes, relay network nodes, aggregated network nodes, and/or disaggregated network nodes, among other examples. In the example shown in FIG. 1, the network node 210a may be a macro network node for a macro cell 230a, the network node 210b may be a pico network node for a pico cell 230b, and the network node 210c may be a femto network node for a femto cell 230c. Various different types of network nodes 210 may generally transmit at different power levels, serve different coverage areas, and/or have different impacts on interference in the wireless communication network 200 than other types of network nodes 210. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 210 may be, may include, or may operate as an RU, a TRP, or a base station that communicates with one or more UEs 220 via a radio access link (which may be referred to as a “Uu” link). The radio access link may include a downlink and an uplink. “Downlink” (or “DL”) refers to a communication direction from a network node 210 to a UE 220, and “uplink” (or “UL”) refers to a communication direction from a UE 220 to a network node 210. Downlink channels may include one or more control channels and one or more data channels. A downlink control channel may be used to transmit downlink control information (DCI) (for example, scheduling information, reference signals, and/or configuration information) from a network node 210 to a UE 220. A downlink data channel may be used to transmit downlink data (for example, user data associated with a UE 220) from a network node 210 to a UE 220. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 220 to a network node 210. An uplink data channel may be used to transmit uplink data (for example, user data associated with a UE 220) from a UE 220 to a network node 210. Uplink control channels may include one or more physical uplink control channels (PUCCHs), and uplink data channels may include one or more physical uplink shared channels (PUSCHs). The downlink and the uplink may each include a set of resources on which the network node 210 and the UE 220 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 220. A UE 220 may be configured with both an uplink BWP and a downlink BWP (where the uplink BWP and the downlink BWP may be the same BWP or different BWPs). A BWP may be dynamically configured (for example, by a network node 210 transmitting a DCI configuration to the one or more UEs 220) and/or reconfigured, which means that a BWP can be adjusted in real-time (or near-real-time) based on changing network conditions in the wireless communication network 200 and/or based on the specific requirements of the one or more UEs 220. This enables more efficient use of the available frequency domain resources in the wireless communication network 200 because fewer frequency domain resources may be allocated to a BWP for a UE 220 (which may reduce the quantity of frequency domain resources that a UE 220 is required to monitor), leaving more frequency domain resources to be spread across multiple UEs 220. Thus, BWPs may also assist in the implementation of lower-capability UEs 220 by facilitating the configuration of smaller bandwidths for communication by such UEs 220.

As indicated above, a BWP may be configured as a subset or a part of a total or full component carrier bandwidth and generally forms or encompasses a set of contiguous common resource blocks (CRBs) within the full component carrier bandwidth. In other words, within the carrier bandwidth, a BWP starts at a CRB and may span a set of consecutive CRBs. Each BWP may be associated with its own numerology (indicating a sub-carrier spacing (SCS) and cyclic prefix (CP)). A UE 220 may be configured with up to four downlink BWPs and up to four uplink BWPs for each serving cell. To enable reasonable UE battery consumption, only one BWP in the downlink and one BWP in the uplink are generally active at a given time on an active serving cell under typical operation. The active BWP defines the operating bandwidth of the UE 220 within the operating bandwidth of the serving cell while all other BWPs with which the UE 220 is configured are deactivated. On deactivated BWPs, the UE 220 does not transmit or receive any communications.

As described above, in some aspects, the wireless communication network 200 may be, may include, or may be included in, an IAB network. In an IAB network, at least one network node 210 is an anchor network node that communicates with a core network. An anchor network node 210 may also be referred to as an IAB donor (or “IAB-donor”). The anchor network node 210 may connect to the core network via a wired backhaul link. For example, an Ng interface of the anchor network node 210 may terminate at the core network. Additionally or alternatively, an anchor network node 210 may connect to one or more devices of the core network that provide a core access and mobility management function (AMF). An IAB network also generally includes multiple non-anchor network nodes 210, which may also be referred to as relay network nodes or simply as IAB nodes (or “IAB-nodes”). Each non-anchor network node 210 may communicate directly with the anchor network node 210 via a wireless backhaul link to access the core network, or may communicate indirectly with the anchor network node 210 via one or more other non-anchor network nodes 210 and associated wireless backhaul links that form a backhaul path to the core network. Some anchor network node 210 or other non-anchor network node 210 may also communicate directly with one or more UEs 220 via wireless access links that carry access traffic. In some examples, network resources for wireless communication (such as time resources, frequency resources, and/or spatial resources) may be shared between access links and backhaul links.

In some examples, any network node 210 that relays communications may be referred to as a relay network node, a relay station, or simply as a relay. A relay may receive a transmission of a communication from an upstream station (for example, another network node 210 or a UE 220) and transmit the communication to a downstream station (for example, a UE 220 or another network node 210). In this case, the wireless communication network 200 may include or be referred to as a “multi-hop network.” In the example shown in FIG. 1, the network node 210d (for example, a relay network node) may communicate with the network node 210a (for example, a macro network node) and the UE 220d in order to facilitate communication between the network node 210a and the UE 220d. Additionally or alternatively, a UE 220 may be or may operate as a relay station that can relay transmissions to or from other UEs 220. A UE 220 that relays communications may be referred to as a UE relay or a relay UE, among other examples.

The UEs 220 may be physically dispersed throughout the wireless communication network 200, and each UE 220 may be stationary or mobile. A UE 220 may be, may include, or may be included in an access terminal, another terminal, a mobile station, or a subscriber unit. A UE 220 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an extended reality (XR) device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 220 and/or a network node 210 may include one or more chips, system-on-chips (SoCs), chipsets, packages, or devices that individually or collectively constitute or comprise a processing system (such as the processing system 110 and/or the processing system 112). The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 220 may include or may be included in a housing that houses components associated with the UE 220 including the processing system.

Some UEs 220 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”). An MTC UE may be, may include, or may be included in or coupled with a robot, an unmanned aerial vehicle or drone, a remote device, a sensor, a meter, a monitor, and/or a location tag. Some UEs 220 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 220 may be considered Customer Premises Equipment, which may include telecommunications devices that are installed at a customer location (such as a home or office) to enable access to a service provider's network (such as included in or in communication with the wireless communication network 200).

Some UEs 220 may be classified according to different categories in association with different complexities and/or different capabilities. UEs 220 in a first category may facilitate massive IoT in the wireless communication network 200, and may offer low complexity and/or cost relative to UEs 220 in a second category. UEs 220 in a second category may include mission-critical IoT devices, legacy UEs, baseline UEs, high-tier UEs, advanced UEs, full-capability UEs, and/or premium UEs that are capable of ultra-reliable low-latency communication (URLLC), enhanced mobile broadband (eMBB), and/or precise positioning in the wireless communication network 200, among other examples. A third category of UEs 220 may have mid-tier complexity and/or capability (for example, a capability between UEs 220 of the first category and UEs 220 of the second capability). A UE 220 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 220 (for example, shown as UE 220a and UE 220c) may communicate directly with one another using sidelink communications (for example, without communicating by way of a network node 210 as an intermediary). As an example, the UE 220a may directly transmit data, control information, or other signaling as a sidelink communication to the UE 220c. This is in contrast to, for example, the UE 220a first transmitting data in an UL communication to a network node 210, which then transmits the data to the UE 220e in a DL communication. In various examples, the UEs 220 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 210 may schedule and/or allocate resources for sidelink communications between UEs 220 in the wireless communication network 200. In some other deployments and configurations, a UE 220 (instead of a network node 210) may perform, or collaborate or negotiate with one or more other UEs to perform, scheduling operations, resource selection operations, and/or other operations for sidelink communications.

In various examples, some of the network nodes 210 and the UEs 220 of the wireless communication network 200 may be configured for full-duplex operation in addition to half-duplex operation. A network node 210 or a UE 220 operating in a half-duplex mode may perform only one of transmission or reception during particular time resources, such as during particular slots, symbols, or other time periods. Half-duplex operation may involve time-division duplexing (TDD), in which DL transmissions of the network node 210 and UL transmissions of the UE 220 do not occur in the same time resources (that is, the transmissions do not overlap in time). In contrast, a network node 210 or a UE 220 operating in a full-duplex mode can transmit and receive communications concurrently (for example, in the same time resources). By operating in a full-duplex mode, network nodes 210 and/or UEs 220 may generally increase the capacity of the network and the radio access link. In some examples, full-duplex operation may involve frequency-division duplexing (FDD), in which DL transmissions of the network node 210 are performed in a first frequency band or on a first component carrier and transmissions of the UE 220 are performed in a second frequency band or on a second component carrier different than the first frequency band or the first component carrier, respectively. In some examples, full-duplex operation may be enabled for a UE 220 but not for a network node 210. For example, a UE 220 may simultaneously transmit an UL transmission to a first network node 210 and receive a DL transmission from a second network node 210 in the same time resources. In some other examples, full-duplex operation may be enabled for a network node 210 but not for a UE 220. For example, a network node 210 may simultaneously transmit a DL transmission to a first UE 220 and receive an UL transmission from a second UE 220 in the same time resources. In some other examples, full-duplex operation may be enabled for both a network node 210 and a UE 220.

In some examples, the UEs 220 and the network nodes 210 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some radio access technologies (RATs) may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

The network node 210 may provide the UE 220 with a configuration of transmission configuration indicator (TCI) states that indicate or correspond to beams that may be used by the UE 220, such as for receiving one or more communications via a physical channel. For example, the network node 210 may indicate (for example, using DCI) an activated TCI state to the UE 220, which the UE 220 may use to generate a beam for receiving one or more communications via the physical channel. A beam indication may be, or may include, a TCI state information element, a beam identifier (ID), spatial relation information, a TCI state ID, a closed loop index, a panel ID, a TRP ID, and/or a sounding reference signal (SRS) set ID, among other examples. A TCI state information element (sometimes referred to as a TCI state herein) may indicate particular information associated with a beam. For example, the TCI state information element may indicate a TCI state identification (for example, a tri-StateID), a quasi-co-location (QCL) type (for example, a qel-Type1, qcl-Type2, qcl-TypeA, qcl-TypeB, qcl-TypeC, or a qel-TypeD, among other examples), a cell identification (for example, a ServCellIndex), a bandwidth part identification (bwp-Id), or a reference signal identification, such as a channel state information (CSI) reference signal (CSI-RS) identification (for example, an NZP-CSI-RS-ResourceId or an SSB-Index, among other examples). Spatial relation information may similarly indicate information associated with an uplink beam. The beam indication may be a joint or separate DL/UL beam indication in a unified TCI framework. In a unified TCI framework, a network node 210 may support common TCI state ID update and activation, which may provide common QCL and/or common UL transmission spatial filters across a set of configured component carriers. This type of beam indication may apply to intra-band carrier aggregation, as well as to joint DL/UL and separate DL/UL beam indications. The common TCI state ID may imply that one reference signal determined according to the TCI state(s) indicated by a common TCI state ID is used to provide QCL Type-D indication and to determine UL transmission spatial filters across the set of configured CCs.

In some aspects, the UE 220 may include a communication manager 240. As described in more detail elsewhere herein, the communication manager 240 may receive one or more criteria for an AI/ML model monitoring operation; perform, for an AI/ML model, the AI/ML model monitoring operation based on a first distribution of inference data associated with the AI/ML model satisfying the one or more criteria; and/or perform, for the AI/ML model, an action based on the AI/ML model monitoring operation. Additionally, or alternatively, the communication manager 240 may perform one or more other operations described herein.

In some aspects, the network node 210 may include a communication manager 250. As described in more detail elsewhere herein, the communication manager 250 may transmit, for a second network entity, one or more criteria for inference data to be used for an AI/ML model monitoring operation for an AI/ML model deployed at the second network entity. Additionally, or alternatively, the communication manager 250 may perform one or more other operations described herein.

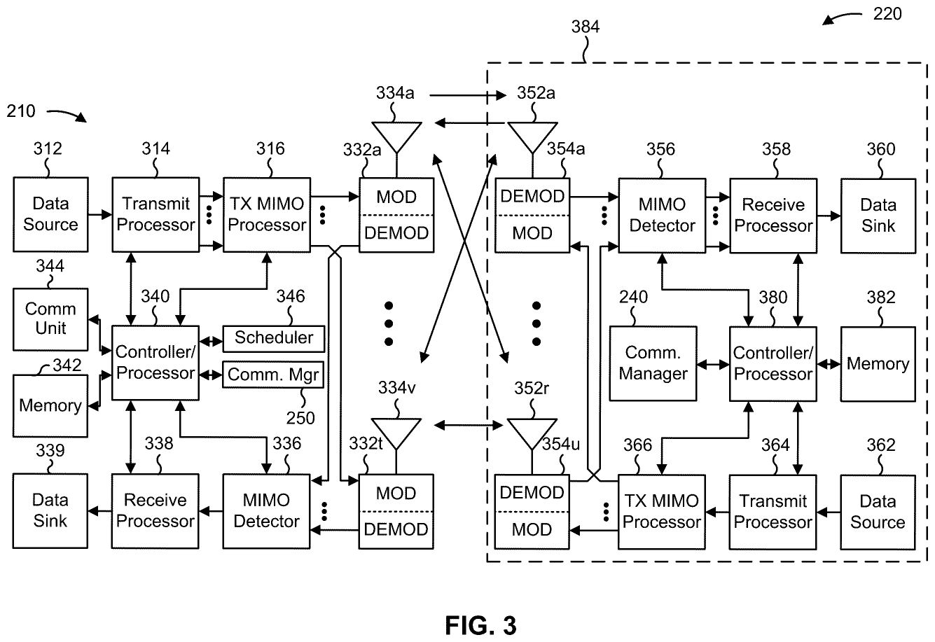

FIG. 3 is a diagram illustrating an example network node 210 in communication with an example UE 220 in a wireless network in accordance with the present disclosure.

As shown in FIG. 3, the network node 210 may include a data source 312, a transmit processor 314, a transmit (TX) MIMO processor 316, a set of modems 332 (shown as 332a through 332t, where t≥1), a set of antennas 334 (shown as 334a through 334v, where v≥1), a MIMO detector 336, a receive processor 338, a data sink 339, a controller/processor 340, a memory 342, a communication unit 344, a scheduler 346, and/or a communication manager 250, among other examples. In some configurations, one or a combination of the antenna(s) 334, the modem(s) 332, the MIMO detector 336, the receive processor 338, the transmit processor 314, and/or the TX MIMO processor 316 may be included in a transceiver of the network node 210. The transceiver may be under control of and used by one or more processors, such as the controller/processor 340, and in some aspects in conjunction with processor-readable code stored in the memory 342, to perform aspects of the methods, processes, and/or operations described herein. In some aspects, the network node 210 may include one or more interfaces, communication components, and/or other components that facilitate communication with the UE 220 or another network node.

The terms “processor,” “controller,” or “controller/processor” may refer to one or more controllers and/or one or more processors. For example, reference to “a/the processor,” “a/the controller/processor,” or the like (in the singular) refers to any one or more of the processors described in connection with FIG. 3, such as a single processor or a combination of multiple different processors. Reference to “one or more processors” refers to any one or more of the processors described in connection with FIG. 3. For example, one or more processors of the network node 210 may include transmit processor 314, TX MIMO processor 316, MIMO detector 336, receive processor 338, and/or controller/processor 340. Similarly, one or more processors of the UE 220 may include MIMO detector 356, receive processor 358, transmit processor 364, TX MIMO processor 366, and/or controller/processor 380.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” refers to any one or more memories of a corresponding device, such as the memory described in connection with FIG. 3. For example, operation described as being performed by one or more memories can be performed by the same subset of the one or more memories or different subsets of the one or more memories.

For downlink communication from the network node 210 to the UE 220, the transmit processor 314 may receive data (“downlink data”) intended for the UE 220 (or a set of UEs that includes the UE 220) from the data source 312 (such as a data pipeline or a data queue). In some examples, the transmit processor 314 may select one or more MCSs for the UE 220 in accordance with one or more channel quality indicators (CQIs) received from the UE 220. The network node 210 may process the data (for example, including encoding the data) for transmission to the UE 220 on a downlink in accordance with the MCS(s) selected for the UE 220 to generate data symbols. The transmit processor 314 may process system information (for example, semi-static resource partitioning information (SRPI)) and/or control information (for example, CQI requests, grants, and/or upper layer signaling) and provide overhead symbols and/or control symbols. The transmit processor 314 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 316 may perform spatial processing (for example, precoding) on the data symbols, the control symbols, the overhead symbols, and/or the reference symbols, if applicable, and may provide a set of output symbol streams (for example, T output symbol streams) to the set of modems 332. For example, each output symbol stream may be provided to a respective modulator component (shown as MOD) of a modem 332. Each modem 332 may use the respective modulator component to process (for example, to modulate) a respective output symbol stream (for example, for orthogonal frequency division multiplexing ((OFDM)) to obtain an output sample stream. Each modem 332 may further use the respective modulator component to process (for example, convert to analog, amplify, filter, and/or upconvert) the output sample stream to obtain a time domain downlink signal. The modems 332a through 332t may together transmit a set of downlink signals (for example, T downlink signals) via the corresponding set of antennas 334.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 200. A data stream (for example, from the data source 312) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 220 to the network node 210, uplink signals from the UE 220 may be received by an antenna 334, may be processed by a modem 332 (for example, a demodulator component, shown as DEMOD, of a modem 332), may be detected by the MIMO detector 336 (for example, a receive (Rx) MIMO processor) if applicable, and/or may be further processed by the receive processor 338 to obtain decoded data and/or control information. The receive processor 338 may provide the decoded data to a data sink 339 (which may be a data pipeline, a data queue, and/or another type of data sink) and provide the decoded control information to a processor, such as the controller/processor 340.

The network node 210 may use the scheduler 346 to schedule one or more UEs 220 for downlink or uplink communications. In some aspects, the scheduler 346 may use DCI to dynamically schedule DL transmissions to the UE 220 and/or UL transmissions from the UE 220. In some examples, the scheduler 346 may allocate recurring time domain resources and/or frequency domain resources that the UE 220 may use to transmit and/or receive communications using an RRC configuration (for example, a semi-static configuration), for example, to perform semi-persistent scheduling (SPS) or to configure a configured grant (CG) for the UE 220.

One or more of the transmit processor 314, the TX MIMO processor 316, the modem 332, the antenna 334, the MIMO detector 336, the receive processor 338, and/or the controller/processor 340 may be included in an RF chain of the network node 210. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 210). In some aspects, the RF chain may be or may be included in a transceiver of the network node 210.

In some examples, the network node 210 may use the communication unit 344 to communicate with a core network and/or with other network nodes. The communication unit 344 may support wired and/or wireless communication protocols and/or connections, such as Ethernet, optical fiber, common public radio interface (CPRI), and/or a wired or wireless backhaul, among other examples. The network node 210 may use the communication unit 344 to transmit and/or receive data associated with the UE 220 or to perform network control signaling, among other examples. The communication unit 344 may include a transceiver and/or an interface, such as a network interface.

The UE 220 may include a set of antennas 352 (shown as antennas 352a through 352r, where r≥1), a set of modems 354 (shown as modems 354a through 354u, where u≥1), a MIMO detector 356, a receive processor 358, a data sink 360, a data source 362, a transmit processor 364, a TX MIMO processor 366, a controller/processor 380, a memory 382, and/or a communication manager 240, among other examples. One or more of the components of the UE 220 may be included in a housing 384. In some aspects, one or a combination of the antenna(s) 352, the modem(s) 354, the MIMO detector 356, the receive processor 358, the transmit processor 364, or the TX MIMO processor 366 may be included in a transceiver that is included in the UE 220. The transceiver may be under control of and used by one or more processors, such as the controller/processor 380, and in some aspects in conjunction with processor-readable code stored in the memory 382, to perform aspects of the methods, processes, or operations described herein. In some aspects, the UE 220 may include another interface, another communication component, and/or another component that facilitates communication with the network node 210 and/or another UE 220.

For downlink communication from the network node 210 to the UE 220, the set of antennas 352 may receive the downlink communications or signals from the network node 210 and may provide a set of received downlink signals (for example, R received signals) to the set of modems 354. For example, each received signal may be provided to a respective demodulator component (shown as DEMOD) of a modem 354. Each modem 354 may use the respective demodulator component to condition (for example, filter, amplify, downconvert, and/or digitize) a received signal to obtain input samples. Each modem 354 may use the respective demodulator component to further demodulate or process the input samples (for example, for OFDM) to obtain received symbols. The MIMO detector 356 may obtain received symbols from the set of modems 354, may perform MIMO detection on the received symbols if applicable, and may provide detected symbols. The receive processor 358 may process (for example, decode) the detected symbols, may provide decoded data for the UE 220 to the data sink 360 (which may include a data pipeline, a data queue, and/or an application executed on the UE 220), and may provide decoded control information and system information to the controller/processor 380.

For uplink communication from the UE 220 to the network node 210, the transmit processor 364 may receive and process data (“uplink data”) from a data source 362 (such as a data pipeline, a data queue, and/or an application executed on the UE 220) and control information from the controller/processor 380. The control information may include one or more parameters, feedback, one or more signal measurements, and/or other types of control information. In some aspects, the receive processor 358 and/or the controller/processor 380 may determine, for a received signal (such as received from the network node 210 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a channel quality indicator (CQI) parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 220 by the network node 210.

The transmit processor 364 may generate reference symbols for one or more reference signals, such as an uplink DMRS, an uplink SRS, and/or another type of reference signal. The symbols from the transmit processor 364 may be precoded by the TX MIMO processor 366, if applicable, and further processed by the set of modems 354 (for example, for DFT-s-OFDM or CP-OFDM). The TX MIMO processor 366 may perform spatial processing (for example, precoding) on the data symbols, the control symbols, the overhead symbols, and/or the reference symbols, if applicable, and may provide a set of output symbol streams (for example, U output symbol streams) to the set of modems 354. For example, each output symbol stream may be provided to a respective modulator component (shown as MOD) of a modem 354. Each modem 354 may use the respective modulator component to process (for example, to modulate) a respective output symbol stream (for example, for OFDM) to obtain an output sample stream. Each modem 354 may further use the respective modulator component to process (for example, convert to analog, amplify, filter, and/or upconvert) the output sample stream to obtain an uplink signal.

The modems 354a through 354u may transmit a set of uplink signals (for example, R uplink signals or U uplink symbols) via the corresponding set of antennas 352. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 220) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 352 or the set of antennas 334 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 334 or an antenna 352 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 220 or network nodes 210 may include different numbers of antenna elements. For example, a UE 220 may include a single antenna element, two antenna elements, four antenna elements, eight antenna elements, or a different number of antenna elements. As another example, a network node 210 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

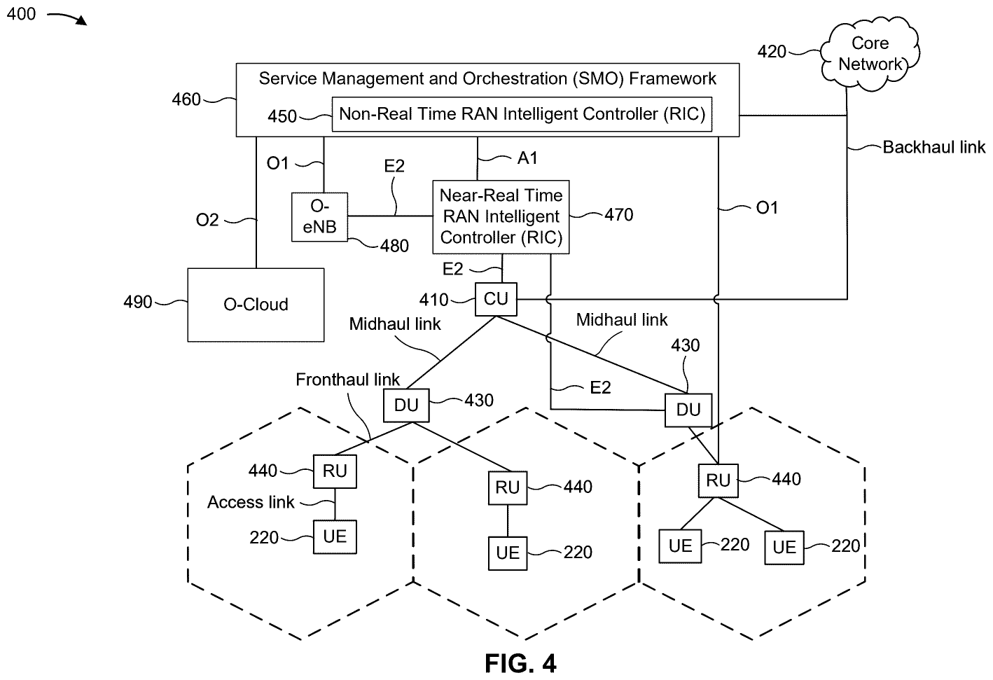

FIG. 4 is a diagram illustrating an example disaggregated base station architecture 400 in accordance with the present disclosure. One or more components of the example disaggregated base station architecture 400 may be, may include, or may be included in one or more network nodes (such one or more network nodes 210). The disaggregated base station architecture 400 may include a CU 410 that can communicate directly with a core network 420 via a backhaul link, or that can communicate indirectly with the core network 420 via one or more disaggregated control units, such as a Non-RT RIC 450 associated with a Service Management and Orchestration (SMO) Framework 460 and/or a Near-RT RIC 470 (for example, via an E2 link). The CU 410 may communicate with one or more DUs 430 via respective midhaul links, such as via F1 interfaces. Each of the DUs 430 may communicate with one or more RUs 440 via respective fronthaul links. Each of the RUs 440 may communicate with one or more UEs 220 via respective RF access links. In some deployments, a UE 220 may be simultaneously served by multiple RUs 440.

Each of the components of the disaggregated base station architecture 400, including the CUS 410, the DUs 430, the RUs 440, the Near-RT RICs 470, the Non-RT RICs 450, and the SMO Framework 460, may include one or more interfaces or may be coupled with one or more interfaces for receiving or transmitting signals, such as data or information, via a wired or wireless transmission medium.

In some aspects, the CU 410 may be logically split into one or more CU-UP units and one or more CU-CP units. A CU-UP unit may communicate bidirectionally with a CU-CP unit via an interface, such as the E1 interface when implemented in an O-RAN configuration. The CU 410 may be deployed to communicate with one or more DUs 430, as necessary, for network control and signaling. Each DU 430 may correspond to a logical unit that includes one or more base station functions to control the operation of one or more RUs 440. For example, a DU 430 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 430, or for communicating signals with the control functions hosted by the CU 410. Each RU 440 may implement lower layer functionality. In some aspects, real-time and non-real-time aspects of control and user plane communication with the RU(s) 440 may be controlled by the corresponding DU 430.

The SMO Framework 460 may support RAN deployment and provisioning of non-virtualized and virtualized network elements. For non-virtualized network elements, the SMO

Framework 460 may support the deployment of dedicated physical resources for RAN coverage requirements, which may be managed via an operations and maintenance interface, such as an O1 interface. For virtualized network elements, the SMO Framework 460 may interact with a cloud computing platform (such as an open cloud (O-Cloud) platform 490) to perform network element life cycle management (such as to instantiate virtualized network elements) via a cloud computing platform interface, such as an O2 interface. A virtualized network element may include, but is not limited to, a CU 410, a DU 430, an RU 440, a non-RT RIC 450, and/or a Near-RT RIC 470. In some aspects, the SMO Framework 460 may communicate with a hardware aspect of a 4G RAN, a 5G NR RAN, and/or a 6G RAN, such as an open eNB (O-eNB) 480, via an O1 interface. Additionally or alternatively, the SMO Framework 460 may communicate directly with each of one or more RUs 440 via a respective O1 interface. In some deployments, this configuration can enable each DU 430 and the CU 410 to be implemented in a cloud-based RAN architecture, such as a vRAN architecture.

The Non-RT RIC 450 may include or may implement a logical function that enables non-real-time control and optimization of RAN elements and resources, artificial intelligence and/or machine learning (AI/ML) workflows including model training and updates, and/or policy-based guidance of applications and/or features in the Near-RT RIC 470. The Non-RT RIC 450 may be coupled to or may communicate with (such as via an A1 interface) the Near-RT RIC 470. The Near-RT RIC 470 may include or may implement a logical function that enables near-real-time control and optimization of RAN elements and resources via data collection and actions via an interface (such as via an E2 interface) connecting one or more CUs 410, one or more DUs 430, and/or an O-eNB with the Near-RT RIC 470.

In some aspects, to generate AI/ML models to be deployed in the Near-RT RIC 470, the Non-RT RIC 450 may receive parameters or external enrichment information from external servers. Such information may be utilized by the Near-RT RIC 470 and may be received at the SMO Framework 460 or the Non-RT RIC 450 from non-network data sources or from network functions. In some examples, the Non-RT RIC 450 or the Near-RT RIC 470 may tune RAN behavior or performance. For example, the Non-RT RIC 450 may monitor long-term trends and patterns for performance and may employ AI/ML models to perform corrective actions via the SMO Framework 460 (such as reconfiguration via an O1 interface) or via creation of RAN management policies (such as A1 interface policies).

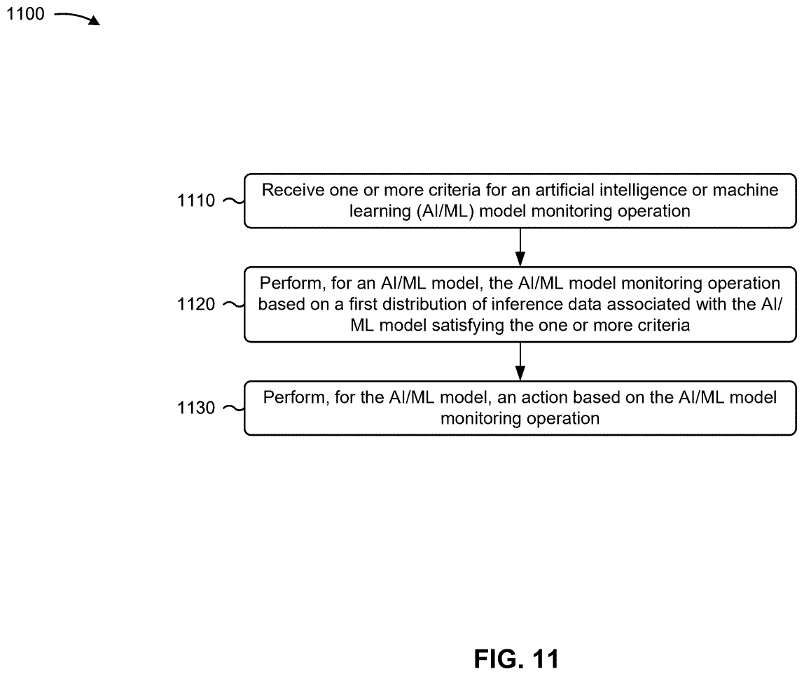

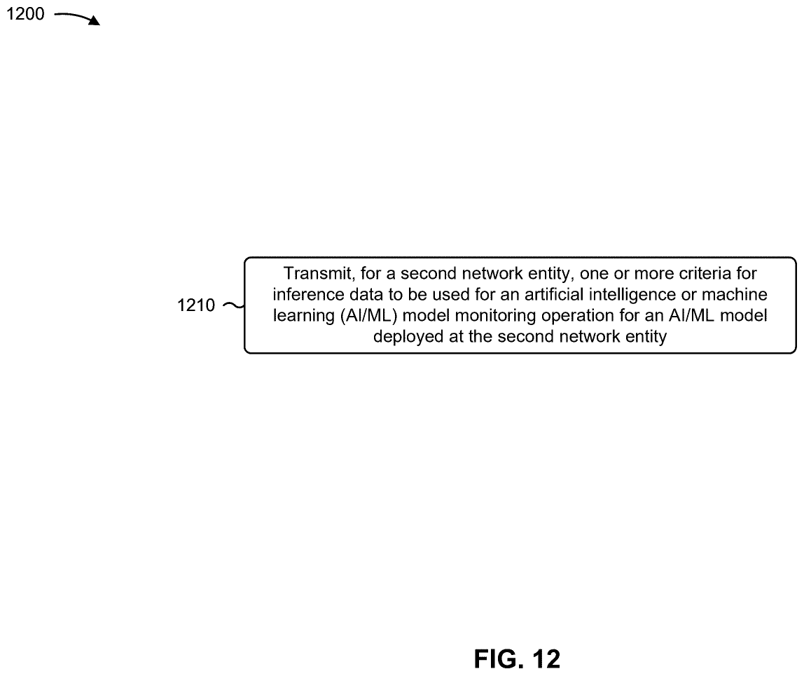

The network node 210, the controller/processor 340 of the network node 210, the UE 220, the controller/processor 380 of the UE 220, the CU 410, the DU 430, the RU 440, or any other component(s) of FIG. 1, 2, 3 or 4 may implement one or more techniques or perform one or more operations associated with inference data distribution criteria for artificial intelligence or machine learning model monitoring, as described in more detail elsewhere herein. For example, the controller/processor 340 of the network node 210, the controller/processor 380 of the UE 220, any other component(s) of FIG. 3, the CU 410, the DU 430, or the RU 440 may perform or direct operations of, for example, process 1100 of FIG. 11, process 1200 of FIG. 12, or other processes as described herein (alone or in conjunction with one or more other processors). The memory 342 may store data and program codes for the network node 210, the network node 210, the CU 410, the DU 430, or the RU 440. The memory 382 may store data and program codes for the UE 220. In some examples, the memory 342 or the memory 382 may include a non-transitory computer-readable medium storing a set of instructions (for example, code or program code) for wireless communication. The memory 342 may include one or more memories, such as a single memory or multiple different memories (of the same type or of different types). The memory 382 may include one or more memories, such as a single memory or multiple different memories (of the same type or of different types). For example, the set of instructions, when executed (for example, directly, or after compiling, converting, or interpreting) by one or more processors of the network node 210, the UE 220, the CU 410, the DU 430, or the RU 440, may cause the one or more processors to perform process 1100 of FIG. 11, process 1200 of FIG. 12, or other processes as described herein. In some examples, executing instructions may include running the instructions, converting the instructions, compiling the instructions, and/or interpreting the instructions, among other examples.

In some aspects, a first network entity includes means for receiving one or more criteria for an AI/ML model monitoring operation; means for performing, for an AI/ML model, the AI/ML model monitoring operation based on a first distribution of inference data associated with the AI/ML model satisfying the one or more criteria; and/or means for performing, for the AI/ML model, an action based on the AI/ML model monitoring operation. In some aspects, the means for the first network entity to perform operations described herein may include, for example, one or more of communication manager 250, transmit processor 314, TX MIMO processor 316, modem 332, antenna 334, MIMO detector 336, receive processor 338, controller/processor 340, memory 342, or scheduler 346. In some other aspects, the means for the first network entity to perform operations described herein may include, for example, one or more of communication manager 240, antenna 352, modem 354, MIMO detector 356, receive processor 358, transmit processor 364, TX MIMO processor 366, controller/processor 380, or memory 382.

In some aspects, a first network entity includes means for transmitting, for a second network entity, one or more criteria for inference data to be used for an AI/ML model monitoring operation for an AI/ML model deployed at the second network entity. In some aspects, the means for the first network entity to perform operations described herein may include, for example, one or more of communication manager 250, transmit processor 314, TX MIMO processor 316, modem 332, antenna 334, MIMO detector 336, receive processor 338, controller/processor 340, memory 342, or scheduler 346. In some other aspects, the means for the first network entity to perform operations described herein may include, for example, one or more of communication manager 240, antenna 352, modem 354, MIMO detector 356, receive processor 358, transmit processor 364, TX MIMO processor 366, controller/processor 380, or memory 382.

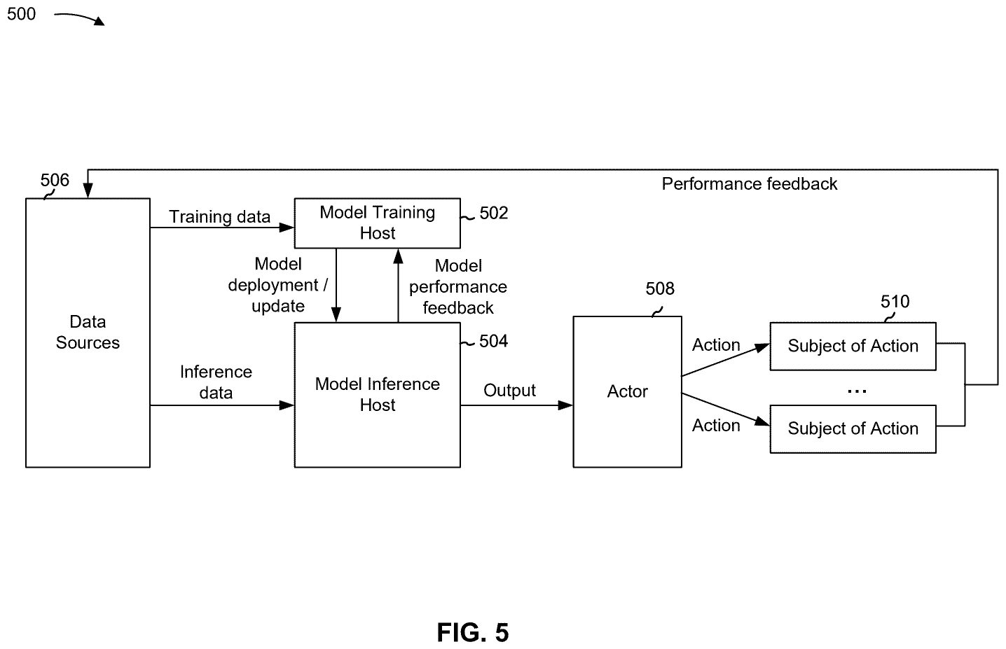

FIG. 5 is a diagram illustrating an example architecture 500 of a functional framework for radio access network (RAN) intelligence enabled by data collection, in accordance with the present disclosure. In some scenarios, the functional framework for RAN intelligence may be enabled by further enhancement of data collection through use cases and/or examples. For example, principles or algorithms for RAN intelligence enabled by AI/ML and the associated functional framework (e.g., the AI functionality and/or the input/output of the component for AI enabled optimization) have been utilized or studied to identify the benefits of AI enabled RAN through possible use cases (e.g., beam management, energy saving, load balancing, mobility management, and/or coverage optimization, among other examples). In one example, as shown by the architecture 500, a functional framework for RAN intelligence may include multiple logical entities, such as a model training host 502, a model inference host 504, data sources 506, and an actor 508.

The model inference host 504 may be configured to run an AI/ML model based on inference data provided by the data sources 506, and the model inference host 504 may produce an output (e.g., a prediction) with the inference data input to the actor 508. The actor 508 may be an element or an entity of a core network or a RAN. For example, the actor 508 may be a UE, a network node, base station (e.g., a gNB), a CU, a DU, and/or an RU, among other examples. In addition, the actor 508 may also depend on the type of tasks performed by the model inference host 504, type of inference data provided to the model inference host 504, and/or type of output produced by the model inference host 504. For example, if the output from the model inference host 504 is associated with position determination, the actor 508 may be a UE, a DU or an RU. In some examples, the model inference host 504 may be hosted on the actor 508. For example, a UE may be the actor 508 and may host the model inference host 504. In some aspects, a UE (e.g., the actor 508) may be a data source 506. For example, the UE may perform a measurement (e.g., an NR measurement), may input the measurement to the AI/ML model at the model inference host 504 (or may provide the measurement to the model inference host 504), and may act based on an output of the AI/ML model.

After the actor 508 receives an output from the model inference host 504, the actor 508 may determine whether to act based on the output. For example, if the actor 508 is a UE and the output from the model inference host 504 is associated with position information, the actor 508 may determine whether to report the position information, reconfigure a beam, among other examples. If the actor 508 determines to act based on the output, in some examples, the actor 508 may indicate the action to at least one subject of action 510.

The data sources 506 may also be configured for collecting data that is used as training data for training an ML model or as inference data for feeding an ML model inference operation. For example, the data sources 506 may collect data from one or more core network and/or RAN entities, which may include the actor 508 or the subject of action 510, and provide the collected data to the model training host 502 for ML model training. In some aspects, the model training host 502 may be co-located with the model inference host 504 and/or the actor 508. For example, the actor 508 or the subject of action 510 may provide performance feedback associated with the beam configuration to the data sources 506, where the performance feedback may be used by the model training host 502 for monitoring or evaluating the ML model performance, such as whether the output (e.g., prediction) provided to the actor 508 is accurate. In some examples, the model training host 502 may monitor or evaluate ML model performance using a training position value, which may be provided by a node (e.g., a UE 220 or a network node 210), as described elsewhere herein. In some examples, if the output provided by the actor 508 is inaccurate (or the accuracy is below an accuracy threshold), then the model training host 502 may determine to modify or retrain the ML model used by the model inference host 504, such as via an ML model deployment/update.

For example, the model inference host 504 may perform an AI/ML model monitoring operation to monitor a performance of the AI/ML model used by the model inference host 504. In some examples, the AI/ML model may be configured and/or trained to operate using inference data that has a given data distribution. For example, the AI/ML model may be designed to operate using inference data that has a data distribution that is the same as, or similar to, a data distribution of training data that was used to train the AI/ML model. The AI/ML model monitoring operation may include the model inference host 504 (or another device or component) monitoring for a mismatch between the data distribution of the inference data and a data distribution of training data that was used to train the AI/ML model. If a difference between the data distribution of the inference data and the data distribution of training data satisfies a threshold, then a performance of the AI/ML model may be degraded. For example, if the inference data is collected in environment or operating conditions that are different than environment and operating conditions under which the AI/ML model has been trained, the performance of the AI/ML model can be significantly degraded. Such scenarios may be referred to as “concept drift detection,” “data drift,” and/or “covariate shift,” among other examples.

In some examples, if the model inference host 504 (or another device or component) detects that a mismatch exists between the data distribution of the inference data and a data distribution of training data (e.g., if data drift is detected), then the model inference host 504 (or another device or component) may perform one or more actions. For example, the one or more actions may include switching the AI/ML model being used by the model inference host 504, performing non-AI/ML based operations, and/or performing online re-training or tuning of the AI/ML model, among other examples. For example, during a lifecycle of the AI/ML model, the model inference host 504 (or another device or component) may monitor performance of the AI/ML model based on data distribution.

As indicated above, FIG. 5 is provided as an example. Other examples may differ from what is described with regard to FIG. 5.

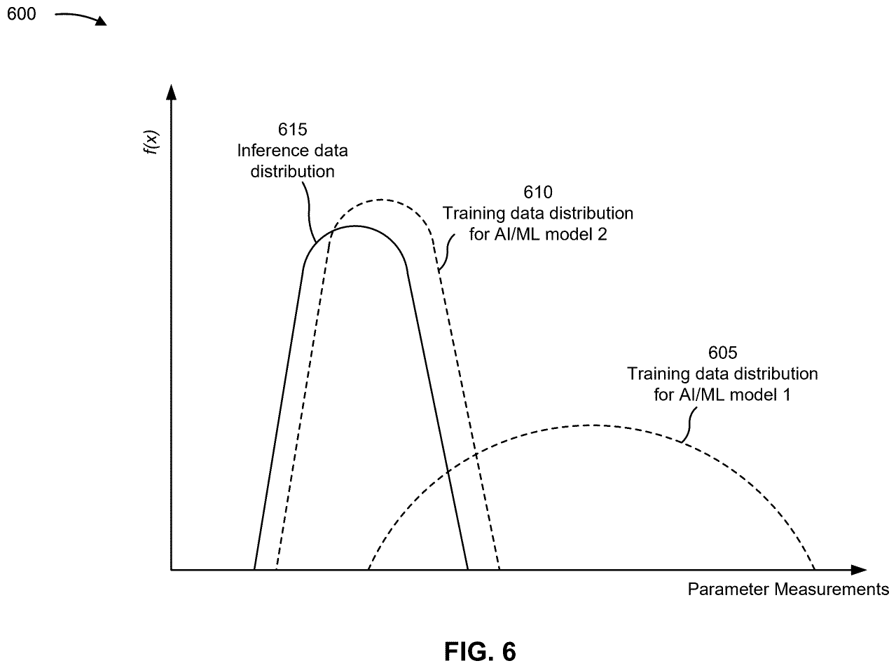

FIG. 6 is a diagram illustrating an example 600 of data distribution of inference data and training data for AI/ML models, in accordance with the present disclosure.

As shown in FIG. 6, a first AI/ML model (e.g., AI/ML model 1) may be associated with a training data distribution 605. The training data distribution 605 may be a normalized input parameter measurement distribution for data used to train the first AI/ML model. The parameter may be any relevant parameter for the AI/ML model. For example, the parameter may be RSRP, RSRQ, signal-to-noise ratio (SNR), or another parameter. As shown in FIG. 6, a second AI/ML model (e.g., AI/ML model 2) may be associated with a training data distribution 610. The training data distribution 610 may be a normalized input parameter measurement distribution for data used to train the second AI/ML model. As shown in FIG. 6, the training data distribution 605 and the training data distribution 610 may be different. For example, the training data may be associated with different environments and/or different operating conditions. For example, the training data distribution 605 may include data that was collected in an outdoor environment, whereas the training data distribution 610 may include data that was collected in an indoor environment.

An entity (e.g., a model inference host) may collect inference data to be input to an AI/ML model (e.g., the first AI/ML model and/or the second AI/ML model). For example, the entity may be configured to use the first AI/ML model and the second AI/ML model for one or more operations, such as temporal beam predictions or another operation. As shown in FIG. 6, the inference data may have a data distribution 615. An AI/ML model monitoring operation may include comparing the data distribution 615 to the training data distribution 605 and/or comparing the data distribution 615 to the training data distribution 610. For example, the entity may determine a similarity metric indicating a similarity or distance between different data distributions. In some aspects, the similarity metric may be a Killback-Leibler (KL) divergence metric, a Kolmogorov-Smirnov (KS) distance (or KS statistic), an Earth mover's distance (EMD) (sometimes referred to as a Wasserstein distance), and/or another similarity metric indicative of a similarity between two data distributions. For example, a similarity metric for the data distribution 615 and the training data distribution 610 may indicate a high level of similarity (e.g., a high distribution similarity because there is a large overlap between the two distributions). A similarity metric for the data distribution 615 and the training data distribution 605 may indicate a low level of similarity (e.g., a low distribution similarity because there is a small overlap between the two distributions). For example, the second AI/ML model may have relatively better performance than the first AI/ML model when using the inference data as an input because the data distribution 615 is more similar to the training data distribution 610 (e.g., of the second AI/ML model). In other words, the second AI/ML model may be better suited for the current operating conditions and/or environment in which the inference data is collected because the training data of the second AI/ML model may have been collected in a similar environment and/or under similar operating conditions.

For example, an AI/ML model monitoring operation may include monitoring a similarity metric between the inference data distribution and the training data distribution for one or more AI/ML models. As an example, if the similarity metric for the inference data distribution and a training data distribution for a given AI/ML model satisfies a threshold, then the entity may continue to use the given AI/ML model or may switch to using the given AI/ML model. Alternatively, if the similarity metric for the inference data distribution and a training data distribution for a given AI/ML model does not satisfy a threshold, then the entity may refrain from performing AI/ML operations, may switch to using a different AI/ML model, and/or may perform online training of the given AI/ML model, among other examples. In some aspects, an AI/ML model may be deployed at a UE. In some examples, the UE may perform the AI/ML model monitoring operation (e.g., may monitor performance metrics and/or similarity metrics of the AI/ML model) and may make decision(s) of model selection, activation, deactivation, switching, and/or fallback operations (e.g., to non-AI/ML operations), among other examples. In other examples, a network node may perform the AI/ML model monitoring operation (e.g., may monitor performance metrics and/or similarity metrics of the AI/ML model) and may make decision(s) of model selection, activation, deactivation, switching, and/or fallback operations (e.g., to non-AI/ML operations), among other examples. In other examples, the UE may perform the AI/ML model monitoring operation (e.g., may monitor performance metrics and/or similarity metrics of the AI/ML model) and a network node may make decision(s) of model selection, activation, deactivation, switching, and/or fallback operations (e.g., to non-AI/ML operations), among other examples.

There may be multiple factors that impact the properties and/or distributions of inference data and output(s) of an AI/ML model. For example, the factors may include signal-to-interference-plus-noise ratio (SINR) levels of an input reference signal used in training of the AI/ML model, a scheduling mode used by a network node (e.g., single user (SU) MIMO scheduling or multi-user (MU) MIMO scheduling), a reference signal type used to obtain the inference data or the training data, an energy per resource element (EPRE) of the reference signal, a change in operating conditions (e.g., a change in bandwidth, a frequency band, a beam, or another communication characteristic), a change in one or more communication parameters (e.g., a quantity of ports, a quantity of antenna panels, a quantity of antenna elements, and/or another communication parameter), and/or a change in operating environment (e.g., rural versus urban, high Doppler versus low Doppler, and/or high interference versus low interference), among other examples.

Therefore, because such factors may impact the performance of an AI/ML model, an entity may perform an AI/ML model monitoring operation (e.g., using data distributions) to detect data drifts and switch or finetune an AI/ML model being used by the entity (or another entity). For example, the entity may use statistical-based AI/ML model monitoring by comparing the inference data distribution with the training data distribution, as described in more detail elsewhere herein. However, the accuracy of data drift detections for an AI/ML model may be based on one or more properties of the inference data distribution. For example, if there are large gaps between measurements included in the inference data distribution, then the inference data distribution may not capture all aspects of the environment which may reduce the accuracy of data drift detection. As another example, if there are more samples (measurements) in the inference data distribution, then the inference data distribution may be more representative of the environment which can increase the accuracy of data drift detection. However, increasing the quantity of samples (e.g., by increasing the monitoring period used to collect the inference data) in the inference data distribution may cause some measurements to become outdated. As a result, this may delay (or slow down) data drift detection for the AI/ML model.

As indicated above. FIG. 6 is provided as an example. Other examples may differ from what is described with regard to FIG. 6.

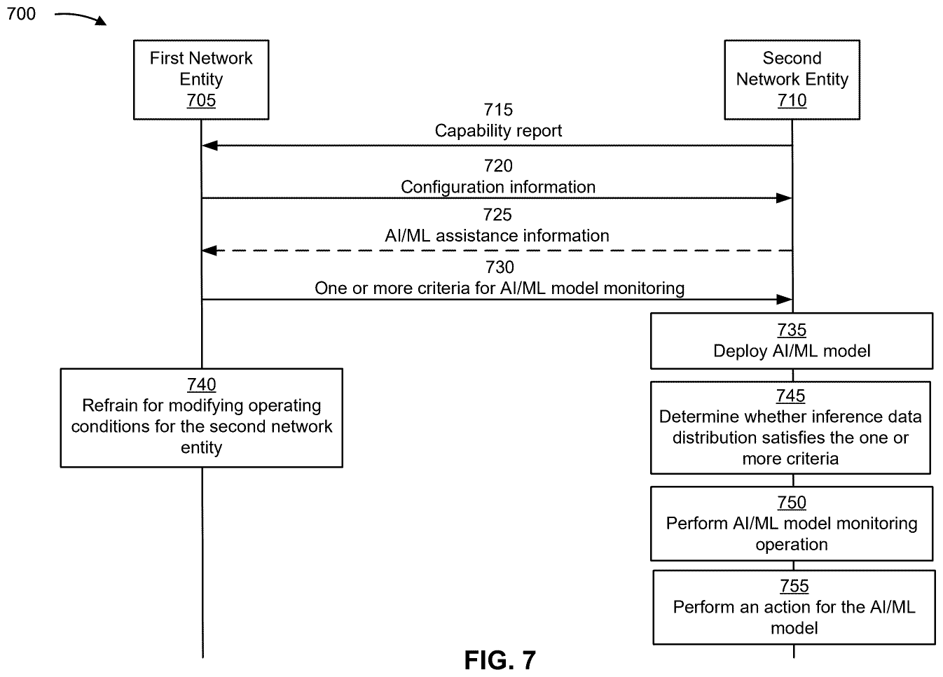

FIG. 7 is a diagram of an example 700 associated with inference data distribution criteria for AI/ML model monitoring, in accordance with the present disclosure. As shown in FIG. 7, a first network entity 705 may communicate with a second network entity 710. The first network entity 705 may be the network entity 102, the network entity 106, a network node 210, a UE 220, a base station, a CU, a DU, and/or an RU. The second network entity 710 may be the network entity 102, the network entity 106, a network node 210, a UE 220, a base station, a CU, a DU, and/or an RU. In some aspects, the first network entity 705 may be a network node 210 and the second network entity 710 may be a UE 220. In some aspects, the first network entity 705 and the second network entity 710 may be part of a wireless network (e.g., the wireless communication network 200). The first network entity 705 and the second network entity 710 may have established a wireless connection prior to operations shown in FIG. 7.

In some aspects, as shown by reference number 715, the second network entity 710 may transmit, and the first network entity 705 may receive, a capability report. The capability report may indicate capability information of the second network entity 710. The second network entity 710 may transmit the capability report via an uplink communication, a UE assistance information (UAI) communication, an uplink control information (UCI) communication, an uplink MAC control element (MAC-CE) communication, an RRC communication, a physical uplink control channel (PUCCH), and/or a physical uplink shared channel (PUSCH), among other examples. The capability report may indicate one or more parameters associated with respective capabilities of the second network entity 710. The one or more parameters may be indicated via respective information elements (IEs) included in the capability report.

The capability report may indicate whether the second network entity 710 supports a feature and/or one or more parameters related to the feature. For example, the capability report may indicate a capability and/or parameter for supporting one or more AI/ML models and/or one or more operations that use an AI/ML model, among other examples. As another example, the capability report may indicate a capability and/or parameter for supporting an AI/ML model monitoring operation, as described in more detail elsewhere herein. One or more operations described herein may be based on capability information of the capabilities report. For example, the second network entity 710 may perform a communication in accordance with the capability information, or may receive configuration information that is in accordance with the capability information.

In some aspects, the capability report may indicate whether the second network entity 710 supports being configured with one or more criteria for an AI/ML model monitoring operation. In some aspects, the capability report may indicate one or more capabilities of the second network entity 710 for collecting, constructing, generating, and/or storing, among other examples, inference data (e.g., an inference data distribution) for one or more AI/ML models. For example, the second network entity 710 may transmit an indication of one or more capabilities for inference data distribution properties for the AI/ML model monitoring operation. As an example, the capability report may indicate a supported quantity of samples (e.g., measurements) that the second network entity 710 is capable of storing for constructing an inference data distribution to be used for the AI/ML model monitoring operation (e.g., the capability report may indicate a maximum quantity of samples that the second network entity 710 can store for constructing the inference data distribution). As another example, the capability report may indicate one or more supported time gaps between samples for the inference data distribution. For example, the capability report may indicate a largest time gap between samples (e.g., measurements) that is supported by the second network entity 710 for constructing the inference data distribution.

In some aspects, the capability report may indicate whether the second network entity 710 supports transmitting an indication of one or more recommended criteria for the AI/ML model monitoring operation. For example, as described herein, the second network entity 710 may be capable of transmitting, to the first network entity 705, an indication of one or more recommended criteria for one or more properties of the inference data distribution to be used for the AI/ML model monitoring operation. In some aspects, the capability report may indicate whether the second network entity 710 supports a feature and/or one or more parameters related to the feature for respective AI/ML use cases. For example, the capability report may indicate an indication of one or more capabilities (such as one or more capabilities described herein) that are applicable to a given AI/ML use case, such as beam management (e.g., temporal beam prediction or spatial domain beam prediction), CSI compression, CSI prediction, and/or positioning, among other examples. In other words, the second network entity 710 may support different capabilities for different AI/ML use cases.

As shown by reference number 720, the first network entity 705 may transmit, and the second network entity 710 may receive, configuration information. In some aspects, the second network entity 710 may receive the configuration information via one or more of system information signaling (e.g., a master information block (MIB) and/or a system information block (SIB), among other examples), RRC signaling, MAC signaling (e.g., one or more MAC-CEs), and/or DCI signaling, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC-CEs and/or one or more DCI messages, among other examples.

In some aspects, the configuration information may indicate information for one or more AI/ML models. For example, the second network entity 710 may be configured with one or more AI/ML models. In some aspects, the first network entity 705 may configure the second network entity 710 with the one or more AI/ML models. In other aspects, another device may configure the second network entity 710 with the one or more AI/ML models. In yet other aspects, the second network entity 710 may have the one or more AI/ML models configured in one or more memories of the second network entity 710 (e.g., via an original equipment manufacturer (OEM) configuration).

The configuration information may indicate that the second network entity 710 is to perform one or more AI/ML operations (e.g., using one or more AI/ML models). The one or more AI/ML operations may include beam management operations (e.g., temporal beam prediction, spatial domain beam prediction, beam blockage prediction), CSI compression, CSI prediction, interference prediction, and/or positioning operations, among other examples.

In some aspects, the configuration information may indicate that the second network entity 710 is to perform an AI/ML model monitoring operation for the one or more AI/ML operations. For example, the second network entity 710 may be configured to perform statistical-based AI/ML model monitoring. For example, the second network entity 710 may be configured to compare an inference data distribution to training data distributions for one or more AI/ML models to detect data drift and/or to evaluate the usefulness of an AI/ML model in different scenarios. For example, the configuration information may indicate one or more thresholds for a similarity metric used to compare an inference data distribution to training data distributions for one or more AI/ML models. Additionally, or alternatively, the one or more thresholds may be defined, or otherwise fixed, by a wireless communication standard, such as the 3GPP. As an example, the AI/ML model monitoring operation may include determining whether a similarity metric (e.g., indicating a similarity level between an inference data distribution and a training data distribution) satisfies the one or more thresholds. The similarity metric may be a KL divergence metric, a KS distance (or KS statistic), an EMD, and/or another similarity metric indicative of a similarity between two data distributions.

In some aspects, the configuration information may indicate that the second network entity 710 is to perform the AI/ML model monitoring operation using inference data having a distribution that satisfies (or meets) one or more criteria. For example, the configuration information may indicate that the second network entity 710 is to only use inference data distributions that satisfy (or meet) the one or more criteria when performing the AI/ML model monitoring operation. In some aspects, the configuration information may indicate the one or more criteria. In some other aspects, the first network entity 705 may indicate the one or more criteria in another communication. In some aspects, the one or more criteria may be defined, or otherwise fixed, by a wireless communication standard, such as the 3GPP. The one or more criteria are described in more detail elsewhere herein, such as in connection with reference number 730.

In some aspects, the configuration information described in connection with reference number 720 and/or the capability report described in connection with reference number 715 may include information transmitted via multiple communications. Additionally, or alternatively, the first network entity 705 may transmit the configuration information, or a communication including at least a portion of the configuration information, before and/or after the second network entity 710 transmits the capability report. For example, the first network entity 705 may transmit a first portion of the configuration information before the second network entity 710 transmits the capability report, the second network entity 710 may transmit at least a portion of the capability report, and the first network entity 705 may transmit a second portion of the configuration information after receiving the capability report.

The second network entity 710 may configure itself, based at least in part on receiving the configuration information described in connection with reference number 720. Additionally, or alternatively, the second network entity 710 may receive an indication to perform the AI/ML model monitoring operation. The second network entity 710 may configure itself, based at least in part on receiving the indication to perform the AI/ML model monitoring operation. The second network entity 710 may configure itself to perform the AI/ML model monitoring operation described herein.

In some aspects, as shown by reference number 725, the second network entity 710 may transmit, and the first network entity 705 may receive, AI/ML assistance information. The AI/ML assistance information may be information to facilitate the first network entity 705 in configuring the one or more criteria for the inference data distribution (e.g., in association with the AI/ML model monitoring operation). The second network entity 710 may transmit the AI/ML assistance information via an uplink communication, a UAI communication, a UCI communication, an MAC-CE communication, an RRC communication, a PUCCH, and/or a PUSCH, among other examples.

In some aspects, the AI/ML assistance information may indicate one or more recommended criteria. For example, the second network entity 710 may transmit, and the first network entity 705 may receive, recommendation information for the AI/ML model monitoring operation. The first network entity 705 may configure the one or more criteria based on (or using) the recommendation information. For example, the second network entity 710 may perform one or more measurements indicative of a current environment and/or operating conditions in which the second network entity 710 is operating. Based on the observance of the environment, the second network entity 710 can recommend one or more inference data distribution properties that should be present in inference data used for the AI/ML model monitoring operation. As an example, the recommendation information may indicate a recommended quantity of samples (e.g., measurements) to be included in the inference data distribution, and/or one or more recommended time durations (e.g., a minimum time duration and/or a maximum time duration) over which samples included in the inference data distribution should span, among other examples. For example, the recommendation information may indicate that the second network entity 710 should use a last N collected samples (e.g., 5,000 samples or another quantity of samples) to construct the inference data distribution to be used for the AI/ML model monitoring operation. As another example, the recommendation information may indicate that the inference data distribution should include samples collected from at least the last M seconds and/or should not include samples that were collected more than L seconds ago.

Additionally, or alternatively, the AI/ML assistance information may indicate an environment and/or one or more operating conditions in which the second network entity 710 is operating. For example, the ML assistance information may indicate movement information, such as Doppler information, and/or a speed of the second network entity 710, among other examples. As another example, the AI/ML assistance information may indicate an environment in which the second network entity 710 is operating (e.g., indoor, outdoor, urban, rural, and/or another environment).

As shown by reference number 730, the first network entity 705 may transmit, and the second network entity 710 may receive, one or more criteria for AI/ML model monitoring. The one or more criteria may be indicative of expected or suitable properties of an inference data distribution to be used for the AI/ML model monitoring operation. The first network entity 705 may transmit, and the second network entity 710 may receive, the one or more criteria via system information signaling, RRC signaling, MAC signaling (e.g., one or more MAC-CEs), and/or DCI signaling, among other examples. In some aspects, one or more criteria may be configured (e.g., via system information signaling or RRC signaling). In some aspects, one or more criteria (or values of one or more criteria) may be dynamically updated by the first network entity 705 via MAC signaling (e.g., one or more MAC-CEs) and/or DCI signaling.

In some aspects, one or more criteria may be defined, or otherwise fixed, by a wireless communication standard, such as the 3GPP. In such examples, the one or more criteria may not be communicated between the first network entity 705 and the second network entity 710. Rather, the second network entity 710 may store an indication of the one or more criteria. In some aspects, the first network entity 705 may transmit, and the second network entity 710 may receive, an indication that the one or more criteria (e.g., stored by the second network entity 710 and/or defined by a wireless communication standard) are to be applied for the AI/ML model monitoring operation.

The first network entity 705 may determine the one or more criteria. For example, the first network entity 705 may determine the one or more criteria based on, using, or otherwise associated with the capability report (e.g., described in connection with reference number 715) and/or the AI/ML assistance information (e.g., described in connection with reference number 725). For example, the first network entity 705 may determine the one or more criteria based on an environment and/or current operating conditions in which the second network entity 710 is currently operating. For example, the first network entity 705 may determine the one or more criteria based on, using, or otherwise associated with, Doppler information, a speed of the second network entity 710, measured SINR levels, a scheduling mode being used by the first network entity 705, a reference signal type being used to collect the inference data, a configured bandwidth for the second network entity 710, an operating frequency being used by the second network entity 710, one or more communication parameters (e.g., a quantity of ports, a quantity of antenna panels, a quantity of antenna elements, and/or another communication parameter), and/or an operating environment of the second network entity 710 (e.g., rural versus urban, high Doppler versus low Doppler, and/or high interference versus low interference), among other examples.

In some aspects, the first network entity 705 may determine one or more criteria that are to be applicable under certain scenarios. For example, the first network entity 705 may configure one or more rules that indicate that if one or more conditions are met, then the second network entity 710 is to apply one or more criteria for determining whether an inference data distribution is to be used for the AI/ML model monitoring operation. As an example, a rule may indicate that if a Doppler measurement satisfies a Doppler threshold, then the second network entity 710 is to apply one or more criteria for determining whether an inference data distribution is to be used for the AI/ML model monitoring operation. In such examples, the second network entity 710 may autonomously (e.g., without receiving explicit instructions to do so) adapt or apply the one or more criteria being used for the AI/ML model monitoring operation based on whether the one or more conditions are met.

The one or more criteria may include timing information associated with the inference data distribution. For example, the timing information may include an amount of time (e.g., an absolute value in minutes, seconds, or milliseconds). In some aspects, the amount of time may indicate a quantity of frames, subframes, slots, and/or symbols (e.g., OFDM symbols), among other examples. The timing information may indicate that the second network entity 710 is to perform the AI/ML model monitoring operation using data, from the inference data, that is collected after the amount of time from a monitoring time (e.g., a time at which the AI/ML monitoring operation is performed). For example, the timing information may indicate a time duration to be used to construct the inference data distribution for statistical-based AI/ML model monitoring. For example, the amount of time may indicate a minimum amount of time. The second network entity 710 may be configured to utilize a configured time duration to store the samples (e.g., measurements) and construct the inference data distribution to ensure that the inference data distribution represents the environment in which the second network entity 710 is operating.

For example, inference data distributions that span short time durations may under-represent the environment and/or may increase false alarms or misdetections in detecting data drifts. Using inference data distributions that span longer time durations may improve the representation of the environment, but may delay detecting data drifts. Therefore, the first network entity 705 may determine the time duration to balance representing the environment with ensuring that data drift detections occur in a timely manner. For example, in fast changing environments (e.g., if the second network entity 710 is moving at high speeds), the timing information may indicate that the inference data distributions are to span relatively short time durations. In slow changing environments (e.g., if the second network entity 710 is moving at low speeds or is stationary), the timing information may indicate that the inference data distributions are to span relatively long time durations.

In some aspects, the timing information may indicate a time window. The time window may be a sliding time window (e.g., that is relative to the monitoring time) indicating inference data to be included in the inference data distribution used in the AI/ML model monitoring operation. For example, the second network entity 710 may perform the AI/ML model monitoring operation using data, from the inference data, that is collected during the time window. For example, the timing information may include a first amount of time and a second amount of time. The second network entity 710 may perform the AI/ML model monitoring operation using data, from the inference data, that is collected after the first amount of time from the monitoring time. The data may be collected at least the second amount of time from the monitoring time. In other words, the first amount of time may define a maximum time duration over which samples (e.g., measurements) can be included in the inference data distribution (e.g., to exclude outdated or old (e.g., stale) data from the inference data distribution). The second amount of time may indicate a minimum time duration needed to construct the inference data distribution (e.g., to ensure that the inference data in the inference data distribution is enough data to accurately represent the environment).

In some aspects, the one or more criteria may include a quantity of measurement samples to be included in the inference data that makes up the inference data distribution. For example, the one or more criteria may include a quantity of samples (e.g., a minimum quantity of samples) to be included in the inference data distribution. For example, more samples (e.g., measurement samples) in the inference data distribution may result in the inference data distribution being more indicative of, or representative of, the environment in which the second network entity 710 is operating. Therefore, the one or more criteria may indicate a quantity of samples to be included in the inference data distribution to improve a likelihood that the inference data distribution is actually indicative of, or representative of, the environment in which the second network entity 710 is operating. For example, the second network entity 710 may be configured to perform the AI/ML model monitoring operation using data, from the inference data, that includes at least the quantity of measurement samples. In some aspects, the one or more criteria may include a maximum quantity of samples to be included in the inference data distribution.

In some aspects, the one or more criteria may include an allowable time gap between measurement samples to be included in the inference data. For example, the allowable time gap may be an allowable time gap between measurements in the inference data distribution (e.g., a minimum time gap between measurement samples included in the inference data distribution). For example, the second network entity 710 may be configured to perform the AI/ML model monitoring operation based on the inference data including measurement samples having respective time gaps that are less than or equal to the allowable time gap. For example, the second network entity 710 may be configured with the allowable time gap to ensure that a time gap between measurements in the inference data distribution causes the inference data distribution to capture the different properties and variations in the environment.

In some aspects, the one or more criteria may be associated with (e.g., may be specific to) a given function or use case for the AI/ML model. For example, the AI/ML model may be configured to perform a function. The one or more criteria may include at least one criterion that is associated with the function (e.g., that is specific to the function). For example, the one or more criteria may be use-case specific requirements on the inference data distribution. For example, the second network entity 710 may be configured to apply one or more conditions based on the second network entity 710 being configured to perform a given function or use case for an AI/ML model. As an example, if the function is a beam prediction function, then the one or more criteria may include a quantity of measurement samples for each beam to be included in the inference data distribution (e.g., a minimum quantity of measurement samples for each beam associated with the beam prediction function). For example, the second network entity 710 may be configured to determine whether the inference data distribution includes quantities of samples from respective beams that satisfy a threshold (e.g., before performing the AI/ML model monitoring operation). As another example, if the function is an interference prediction function, then a criterion may include the inference data distribution including a range of interference measurements that satisfy a threshold.

In some aspects, the one or more criteria may be associated with one or more condition parameters. For example, the one or more criteria may be conditional (e.g., may be conditionally applied) based on, or subject to, one or more factors (e.g., the one or more condition parameters). The one or more condition parameters may include a Doppler parameter, a speed parameter, or a delay spread parameter, among other examples. For example, the second network entity 710 may be configured to detect the one or more condition parameters and apply the one or more criteria to the performance of the AI/ML model monitoring operation based on the detection of the one or more condition parameters. For example, the second network entity 710 may be configured to apply some criteria only in certain operating conditions (e.g., as indicated by the one or more condition parameters). In some aspects, the second network entity 710 may transmit, and the first network entity 705 may receive, information associated with the one or more condition parameters (e.g., in the AI/ML assistance information). The first network entity 705 may configure the one or more criteria and/or the one or more condition parameters based on the information. For example, the information may include a speed, Doppler information, delay spread information, and/or other information.

For example, a moving entity may be more likely to experience data drift (change in the environment) compared to a stationary entity. Therefore, if a speed of the second network entity 710 satisfies a speed threshold, then the second network entity 710 may apply a first one or more criteria for the AI/ML model monitoring operation (e.g., the second network entity 710 may be configured to collect an inference data distribution that includes S samples before performing the AI/ML model monitoring operation). If the speed of the second network entity 710 does not satisfy the speed threshold, then the second network entity 710 may apply a second one or more criteria for the AI/ML model monitoring operation (e.g., the second network entity 710 may be configured to collect an inference data distribution that includes F samples before performing the AI/ML model monitoring operation, where F is greater than S). In other words, at higher speeds, the second network entity 710 may use an inference data distribution that includes fewer samples to ensure that the second network entity 710 is able to quickly detect data drifts in a scenario where the second network entity 710 is more likely to experience data drift. At lower speeds, the second network entity 710 may use an inference data distribution that includes more samples to improve a likelihood that the inference data distribution is representative of the environment.

As shown by reference number 735, the second network entity 710 may deploy an AI/ML model. For example, the second network entity 710 may be, or may include, a model inference host (e.g., a model inference host 504). In some aspects, the second network entity 710 may be an actor 508.

As shown by reference number 740, the first network entity 705 may refrain from modifying, during a monitoring time of an AI/ML model monitoring operation at the second network entity 710, one or more operating conditions for the second network entity 710. For example, the first network entity 705 may indicate (or determine) a monitoring time during which the second network entity 710 is to perform the AI/ML model monitoring operation. The first network entity 705 may refrain from changing the operating conditions of the second network entity 710 (e.g., that are controlled or set by the first network entity 705) during the duration of the AI/ML model monitoring operation. For example, based on indicating a duration of the AI/ML model monitoring operation, the first network entity 705 may refrain from changing the operating conditions of the second network entity 710 during the duration. As an example, the one or more operating conditions may include a scheduling mode used by a network node (e.g., SU MIMO scheduling or MU MIMO scheduling), a beam codebook, a bandwidth, and/or an operating frequency or operating band, among other examples. This may ensure that the second network entity 710 is enabled to collect inference data for the AI/ML model monitoring operation that is not impacted or changed by a change in the one or more operating conditions. This may improve the accuracy of data drift detections by the second network entity 710 as part of the AI/ML model monitoring operation.

As shown by reference number 745, the second network entity 710 may determine whether an inference data distribution satisfies the one or more criteria indicated by (e.g., configured by) the first network entity 705. For example, the second network entity 710 may perform one or more measurements to obtain one or more samples (e.g., measurement samples). The one or more samples may be inference data, as described elsewhere herein. The second network entity 710 may determine whether an inference data distribution of the collected data satisfies the one or more criteria. As used herein, “satisfying” a criterion may refer to a value satisfying a threshold, and/or a condition being detected, among other examples. In other aspects, another entity, such as the first network entity 705, may determine whether an inference data distribution satisfies the one or more criteria. In such example, the second network entity 710 may transmit, and the other entity may receive, the inference data distribution. The other entity may determine whether the inference data distribution satisfies the one or more criteria in a similar manner as described herein.

For example, the second network entity 710 may determine whether a quantity of samples included in the inference data distribution satisfies a threshold indicated by a criterion. As another example, the second network entity 710 may generate the inference data distribution by obtaining samples that satisfy one or more time criteria indicated by the one or more criteria. For example, the second network entity 710 may obtain samples that have occurred less than or equal to an amount of time from a monitoring time (e.g., ensuring that the inference data distribution does not include old or stale samples). Additionally, the second network entity 710 may determine if an amount of time over which the inference data distribution spans satisfies a time threshold (e.g., ensuring that the inference data distribution spans at least a minimum amount of time).

As another example, the second network entity 710 may determine whether a duration of time gaps between consecutive (e.g., consecutive in time) samples satisfies a time gap threshold (e.g., indicated by the one or more criteria). For example, the second network entity 710 may determine whether the samples have respective time gaps that are less than or equal to the allowable time gap. If the inference data distribution includes samples having one or more time gaps that are greater than the allowable time gap, then the second network entity 710 may determine that the one or more criteria are not satisfied (e.g., and may not use the inference data distribution for the AI/ML model monitoring operation).

As shown by reference number 750, the second network entity 710 may perform the AI/ML model monitoring operation. For example, if the inference data distribution satisfies the one or more criteria, then the second network entity 710 may perform the AI/ML model monitoring operation. In other aspects, another entity, such as the first network entity 705, may perform the AI/ML model monitoring operation. For example, the second network entity 710 may transmit, and the other entity may receive, the inference data distribution (e.g., based on, in response to, or otherwise associated with the inference data distribution satisfying the one or more criteria). The other entity may perform the AI/ML model monitoring operation in a similar manner as described herein.

The second network entity 710 may perform the AI/ML model monitoring operation by comparing the inference data distribution to a training data distribution for the deployed AI/ML model. For example, the second network entity may compare, for the AI/ML model, a first distribution (e.g., the inference data distribution) to a second distribution of training data (e.g., the training data distribution) associated with the AI/ML model. The second network entity 710 may determine, based on the comparison, a similarity metric indicating a similarity of the first distribution and the second distribution. The AI/ML model monitoring operation may include determining whether the similarity metric satisfies a similarity threshold.

In some aspects, the similarity threshold may be based on or associated with the inference data distribution. For example, the second network entity 710 may use different similarity thresholds for inference data distributions having different properties (e.g., having different quantities of samples or spanning different durations). For example, as a quantity of samples in the inference data distribution increases, the inference data distribution may become more representative of the environment. As a result, a confidence level that the similarity metric is an accurate indicator of data draft may be improved. Therefore, for inference data distributions including more samples, a smaller similarity threshold (e.g., a stricter threshold) may be used by the second network entity 710. For example, if there are fewer samples included in the inference data distribution, the second network entity 710 may be less confident that the inference data distribution is an accurate representation of the environment in which the second network entity 710 is operating. Therefore, in such examples, the second network entity 710 may use a similarity threshold that is more conservative, in order to avoid unnecessarily performing operations to switch or tune the AI/ML model.

As shown by reference number 755, the second network entity 710 may perform an action for the AI/ML model based on performing the AI/ML model monitoring operation. For example, the action may be based on, in response to, or otherwise associated with whether the similarity metric satisfies the similarity threshold. In some aspects, another entity, such as the first network entity 705, may perform the action (e.g., rather than the second network entity 710). In such examples, the second network entity 710 may transmit, and the other entity may receive, an indication of whether the similarity metric satisfies the similarity threshold (e.g., an indication of a result of the AI/ML model monitoring operation). The other entity may perform the action in a similar manner as described herein.

For example, if the similarity metric satisfies the similarity threshold, then the action may include continuing a use of the AI/ML model. For example, if a result of the AI/ML model monitoring operation indicates that the inference data distribution has a sufficient similarity to the training data distribution, then the second network entity 710 may continue to use the AI/ML model.

As another example, if the similarity metric does not satisfy the similarity threshold, then the action may include switching the AI/ML model, refraining from using the AI/ML model, training the AI/ML model, and/or tuning one or more parameters of the AI/ML model, among other examples. For example, if a result of the AI/ML model monitoring operation indicates that the inference data distribution does not have a sufficient similarity to the training data distribution, then the second network entity 710 may perform one or more operations to modify or stop a use of the AI/ML model. In such examples, the one or more actions may include model selection, model deactivation, switching the AI/ML model to another model, and/or fallback operations (e.g., to non-AI/ML operations), among other examples. For example, the second network entity 710 may switch the AI/ML model to a second AI/ML model. As another example, the second network entity 710 may perform one or more training operations. As another example, the second network entity 710 may perform a function (e.g., that the AI/ML model is configured to perform) via a non-AI/ML operation.

As indicated above, FIG. 7 is provided as an example. Other examples may differ from what is described with regard to FIG. 7.

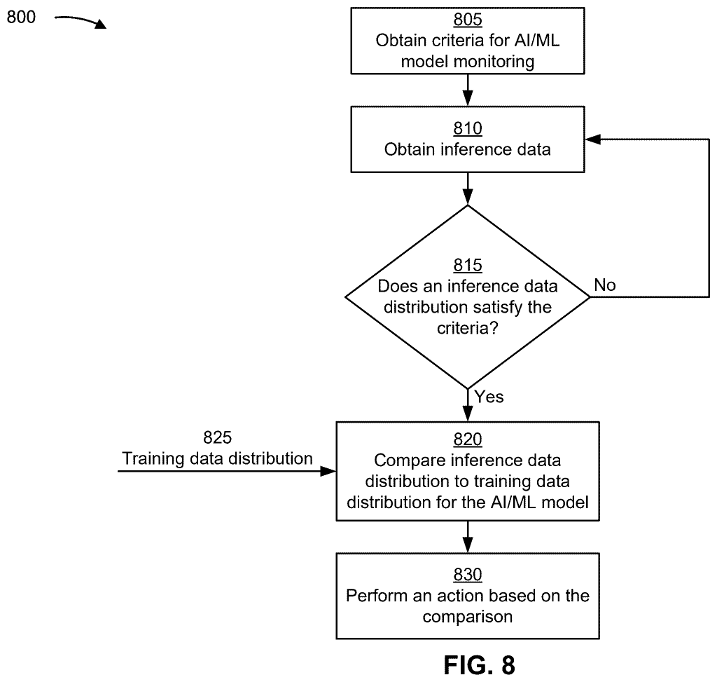

FIG. 8 is a diagram of an example 800 associated with inference data distribution criteria for AI/ML model monitoring, in accordance with the present disclosure. FIG. 8 depicts a process performed by a network entity, such as the second network entity 710.

The process may include obtaining one or more criteria for AI/ML model monitoring (block 805). For example, the network entity may obtain the one or more criteria for AI/ML model monitoring. In some aspects, the network entity may be configured with the one or more criteria. The one or more criteria may include similar criteria as described elsewhere herein, such as in connection with FIG. 7.

The process may include obtaining inference data (block 810). For example, the network entity may obtain the inference data. The inference data may be an input for an AI/ML model. For example, the network entity may perform one or more measurements (e.g., of reference signals or other signals) to obtain the inference data. The inference data may be associated with an inference data distribution (e.g., a normalized input interference distribution observed during inference for an AI/ML model).

The process may include determining whether the inference data distribution satisfies the one or more criteria (block 815). For example, the network entity may determine whether the inference data distribution satisfies the one or more criteria. If the inference data distribution does not satisfy the one or more criteria (block 810-No), then the process may include continuing to obtain or collect inference data (e.g., as depicted and described in connection with block 810). For example, the network entity may refrain from using the inference data distribution in an AI/ML model monitoring operation.

If the inference data distribution satisfies the one or more criteria (block 810—Yes), then the process may include comparing the inference data distribution to a training data distribution for the AI/ML model (block 820). For example, the network entity may compare the inference data distribution to a training data distribution 825 for the AI/ML model. In other words, the network entity may perform an AI/ML model monitoring operation for the AI/ML model (e.g., using the inference data distribution) if the inference data distribution satisfies the one or more criteria. For example, the network entity may obtain a training data distribution 825 for the AI/ML model (e.g., from another network entity or from one or more memories of the network entity). The network entity may determine a similarity metric indicating a similarity between the inference data distribution and the training data distribution 825.

The process may include performing an action based on the comparison (block 830). For example, the network entity may perform an action based on the comparison. For example, if a result of the AI/ML model monitoring operation indicates that the inference data distribution and the training data distribution 825 are similar (e.g., if the similarity metric satisfies a similarity threshold), then the network entity may continue to use the AI/ML model. Alternatively, if a result of the AI/ML model monitoring operation indicates that the inference data distribution and the training data distribution 825 are dissimilar (e.g., if the similarity metric does not satisfy the similarity threshold), then the network entity may perform a corrective action. The corrective action may include switching the AI/ML model to a different AI/ML model, retraining the AI/ML model, fine-tuning one or more parameters of the AI/ML model, and/or falling back to non-AI/ML operations, among other examples.

As indicated above, FIG. 8 is provided as an example. Other examples may differ from what is described with regard to FIG. 8.

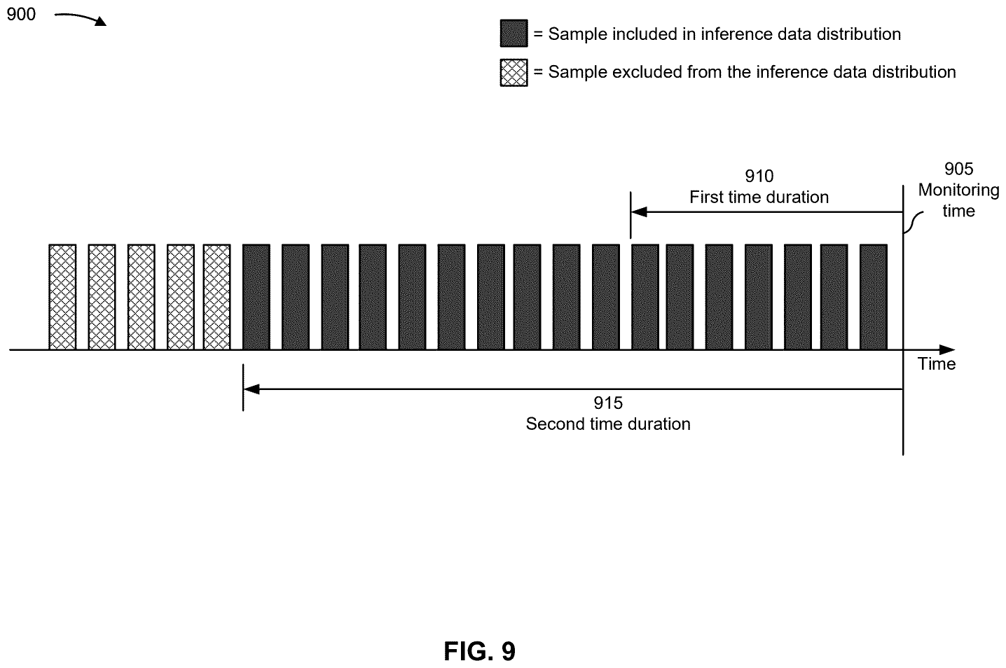

FIG. 9 is a diagram of an example 900 associated with timing criteria for an inference data distribution for AI/ML model monitoring, in accordance with the present disclosure.

As shown in FIG. 9, a network entity may obtain or collect samples to be used as an input to an AI/ML model. For example, the samples may be inference data, as described elsewhere herein. The network entity may collect an inference data distribution to be used for an AI/ML model monitoring operation (e.g., a statistical-based AI/ML model monitoring operation). The position of the samples as depicted in FIG. 9 may indicate a time at which a given sample was obtained or collected. The network entity may perform the ML model monitoring operation at, or after, a monitoring time 905. The network entity may collect or generate the inference data distribution based on one or more timing criteria.

For example, the network entity may determine that the inference data distribution spans at least a first time duration 910. For example, the first time duration 910 may be a minimum amount of time that the inference data distribution is to span to be used for the AI/ML model monitoring operation. If the samples do not span at least the first time duration 910, then the network entity may refrain from using the inference data distribution for the AI/ML model monitoring operation.

Additionally, the network entity may determine one or more samples to be excluded from (e.g., not included in) the inference data distribution using a second time duration 915. The second time duration 915 may be a maximum duration that the inference data distribution is to span. For example, the network entity may exclude any samples that were collected before the second time duration 915 relative to the monitoring time 905 from the inference data distribution. As described elsewhere herein, the first time duration 910 and/or the second time duration 915 may be based on an environment and/or operating conditions of the network entity (e.g., that is deploying the AI/ML model).

As indicated above, FIG. 9 is provided as an example. Other examples may differ from what is described with regard to FIG. 9.

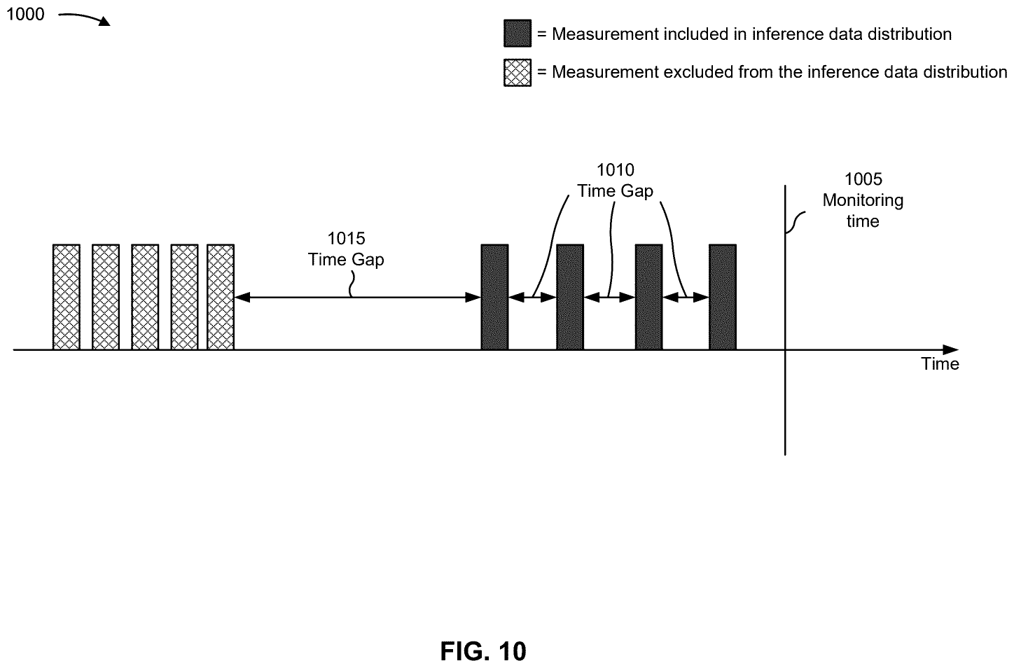

FIG. 10 is a diagram of an example 1000 associated with timing criteria for an inference data distribution for AI/ML model monitoring, in accordance with the present disclosure.

As shown in FIG. 10, a network entity may obtain or collect samples to be used as an input to an AI/ML model. For example, the samples may be inference data, as described elsewhere herein. The network entity may collect an inference data distribution to be used for an AI/ML model monitoring operation (e.g., a statistical-based AI/ML model monitoring operation). The position of the samples as depicted in FIG. 10 may indicate a time at which a given sample was obtained or collected. The network entity may perform the ML model monitoring operation at, or after, a monitoring time 1005. The network entity may collect or generate the inference data distribution based on one or more timing criteria. The one or more timing criteria may include allowable time gaps between samples included in the inference data distribution.

For example, as shown in FIG. 10, the samples may be separated in time by respective time gaps. In some aspects, a criterion for AI/ML model monitoring may include an allowable time gap (e.g., a time gap threshold). If a time gap between two samples satisfies the time gap threshold (e.g., is less than or equal to the allowable time gap), then the network entity may determine that the two samples may be included in the inference data distribution. For example, the time gaps 1010 depicted in FIG. 10 may satisfy the time gap threshold. If a time gap between two samples does not satisfy the time gap threshold (e.g., is greater than the allowable time gap), then the network entity may determine that at least the sample that was collected first in time may not be included in the inference data distribution. For example, the time gap 1015 depicted in FIG. 10 may not satisfy the time gap threshold. In some aspects, any samples collected prior to the sample that was collected first in time (e.g., before the time gap 1015) may be excluded from the inference data distribution. This improves a likelihood that the inference data distribution accurately represents the environment and captures changes in the environment.

As indicated above, FIG. 10 is provided as an example. Other examples may differ from what is described with regard to FIG. 10.

FIG. 11 is a diagram illustrating an example process 1100 performed, for example, at a network entity or an apparatus of a network entity, in accordance with the present disclosure. Example process 1100 is an example where the apparatus or the network entity (e.g., the second network entity 710, the network entity 102, the network entity 106, a network node 210, a UE 220, a base station, a CU, a DU, and/or an RU) performs operations associated with inference data distribution criteria for AI/ML model monitoring.

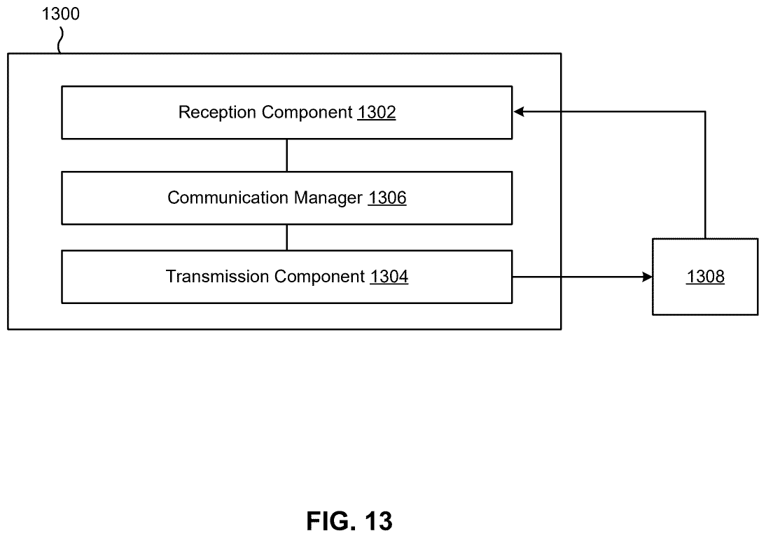

As shown in FIG. 11, in some aspects, process 1100 may include receiving one or more criteria for an AI/ML model monitoring operation (block 1110). For example, the network entity (e.g., using reception component 1302 and/or communication manager 1306, depicted in FIG. 13) may receive one or more criteria for an AI/ML model monitoring operation, as described above.

As further shown in FIG. 11, in some aspects, process 1100 may include performing, for an AI/ML model, the AI/ML model monitoring operation based on a first distribution of inference data associated with the AI/ML model satisfying the one or more criteria (block 1120). For example, the network entity (e.g., using communication manager 1306, depicted in FIG. 13) may perform, for an AI/ML model, the AI/ML model monitoring operation based on a first distribution of inference data associated with the AI/ML model satisfying the one or more criteria, as described above.

As further shown in FIG. 11, in some aspects, process 1100 may include performing, for the AI/ML model, an action based on the AI/ML model monitoring operation (block 1130). For example, the network entity (e.g., using communication manager 1306, depicted in FIG. 13) may perform, for the AI/ML model, an action based on the AI/ML model monitoring operation, as described above.

Process 1100 may include additional aspects, such as any single aspect or any combination of aspects described below and/or in connection with one or more other processes described elsewhere herein.

In a first aspect, performing the AI/ML model monitoring operation includes comparing, for the AI/ML model, the first distribution to a second distribution of training data associated with the AI/ML model based on the first distribution satisfying the one or more criteria.

In a second aspect, alone or in combination with the first aspect, the one or more criteria include timing information associated with the first distribution.

In a third aspect, alone or in combination with one or more of the first and second aspects, the timing information includes an amount of time, and performing the AI/ML model monitoring operation includes performing the AI/ML model monitoring operation using data, from the inference data, that is collected after the amount of time from a monitoring time.

In a fourth aspect, alone or in combination with one or more of the first through third aspects, the timing information includes a time window, and performing the AI/ML model monitoring operation includes performing the AI/ML model monitoring operation using data, from the inference data, that is collected during the time window.

In a fifth aspect, alone or in combination with one or more of the first through fourth aspects, the timing information includes a first amount of time and a second amount of time, and performing the AI/ML model monitoring operation includes performing the AI/ML model monitoring operation using data, from the inference data, that is collected after the first amount of time from a monitoring time, and the data is collected at least the second amount of time from the monitoring time.

In a sixth aspect, alone or in combination with one or more of the first through fifth aspects, the one or more criteria include a quantity of measurement samples to be included in the inference data.

In a seventh aspect, alone or in combination with one or more of the first through sixth aspects, performing the AI/ML model monitoring operation includes performing the AI/ML model monitoring operation using data, from the inference data, that includes at least the quantity of measurement samples.

In an eighth aspect, alone or in combination with one or more of the first through seventh aspects, the one or more criteria include an allowable time gap between measurement samples to be included in the inference data.

In a ninth aspect, alone or in combination with one or more of the first through eighth aspects, performing the AI/ML model monitoring operation includes performing the AI/ML model monitoring operation based on the inference data including measurement samples having respective time gaps that are less than or equal to the allowable time gap.

In a tenth aspect, alone or in combination with one or more of the first through ninth aspects, the AI/ML model is configured to perform a function, and the one or more criteria include at least one criterion that is associated with the function.

In an eleventh aspect, alone or in combination with one or more of the first through tenth aspects, the one or more criteria are associated with one or more condition parameters, and performing the AI/ML model monitoring operation includes detecting the one or more condition parameters, and applying the one or more criteria to the performance of the AI/ML model monitoring operation based on the detection of the one or more condition parameters.

In a twelfth aspect, alone or in combination with one or more of the first through eleventh aspects, the one or more condition parameters include at least one of a Doppler parameter, a speed parameter, or a delay spread parameter.

In a thirteenth aspect, alone or in combination with one or more of the first through twelfth aspects, process 1100 includes transmitting information associated with the one or more condition parameters, where the one or more criteria are based on the information.

In a fourteenth aspect, alone or in combination with one or more of the first through thirteenth aspects, performing the AI/ML model monitoring operation includes comparing, for the AI/ML model, the first distribution to a second distribution of training data associated with the AI/ML model, and determining, based on the comparison, a similarity metric indicating a similarity of the first distribution and the second distribution.

In a fifteenth aspect, alone or in combination with one or more of the first through fourteenth aspects, performing the action includes performing the action based on whether the similarity metric satisfies a threshold.

In a sixteenth aspect, alone or in combination with one or more of the first through fifteenth aspects, the threshold is based on a quantity of measurement samples included in the inference data.

In a seventeenth aspect, alone or in combination with one or more of the first through sixteenth aspects, process 1100 includes transmitting recommendation information for the AI/ML model monitoring operation, where the one or more criteria are based on the recommendation information.

In an eighteenth aspect, alone or in combination with one or more of the first through seventeenth aspects, process 1100 includes transmitting a capability report indicating one or more capabilities for the AI/ML model monitoring operation, where the one or more criteria are based on the one or more capabilities.

In a nineteenth aspect, alone or in combination with one or more of the first through eighteenth aspects, performing the action includes performing one or more AI/ML operations using the AI/ML model.

In a twentieth aspect, alone or in combination with one or more of the first through nineteenth aspects, process 1100 includes switching the AI/ML model to a second AI/ML model.

In a twenty-first aspect, alone or in combination with one or more of the first through twentieth aspects, performing the action includes performing, for the AI/ML model, one or more training operations.

In a twenty-second aspect, alone or in combination with one or more of the first through twenty-first aspects, the AI/ML model is associated with a function, and performing the action includes performing the function via a non-AI/ML operation.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a first network entity or an apparatus of a first network entity, in accordance with the present disclosure. Example process 1200 is an example where the apparatus or the first network entity (e.g., first network entity 705, the network entity 102, the network entity 106, a network node 210, a UE 220, a base station, a CU, a DU, and/or an RU) performs operations associated with inference data distribution criteria for AI/ML model monitoring.

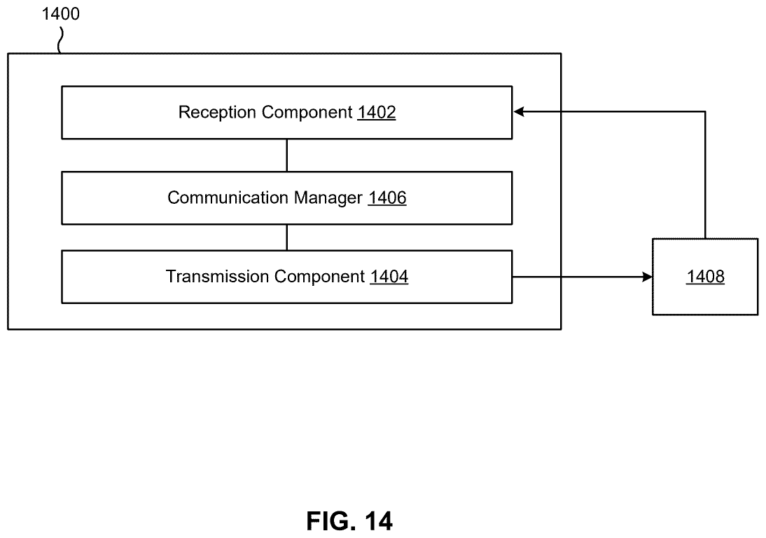

As shown in FIG. 12, in some aspects, process 1200 may include transmitting, for a second network entity, one or more criteria for inference data to be used for an AI/ML model monitoring operation for an AI/ML model deployed at the second network entity (block 1210). For example, the first network entity (e.g., using transmission component 1404 and/or communication manager 1406, depicted in FIG. 14) may transmit, for a second network entity, one or more criteria for inference data to be used for an AI/ML model monitoring operation for an AI/ML model deployed at the second network entity, as described above.

Process 1200 may include additional aspects, such as any single aspect or any combination of aspects described below and/or in connection with one or more other processes described elsewhere herein.

In a first aspect, the one or more criteria include timing information associated with the first distribution.

In a second aspect, alone or in combination with the first aspect, the timing information includes an amount of time during which the inference data is to be collected for the AI/ML model monitoring operation.

In a third aspect, alone or in combination with one or more of the first and second aspects, the timing information includes a time window during which the inference data is to be collected for the AI/ML model monitoring operation.

In a fourth aspect, alone or in combination with one or more of the first through third aspects, the timing information includes a first amount of time and a second amount of time for a collection of the inference data for the AI/ML model monitoring operation.

In a fifth aspect, alone or in combination with one or more of the first through fourth aspects, the one or more criteria include a quantity of measurement samples to be included in the inference data.

In a sixth aspect, alone or in combination with one or more of the first through fifth aspects, the one or more criteria include an allowable time gap between measurement samples to be included in the inference data.

In a seventh aspect, alone or in combination with one or more of the first through sixth aspects, the AI/ML model is configured to perform a function, and the one or more criteria include at least one criterion that is associated with the function.

In an eighth aspect, alone or in combination with one or more of the first through seventh aspects, the one or more criteria are associated with one or more condition parameters.

In a ninth aspect, alone or in combination with one or more of the first through eighth aspects, the one or more condition parameters include at least one of a Doppler parameter, a speed parameter, or a delay spread parameter.

In a tenth aspect, alone or in combination with one or more of the first through ninth aspects, process 1200 includes receiving information associated with the one or more condition parameters, where the one or more criteria are based on the information.

In an eleventh aspect, alone or in combination with one or more of the first through tenth aspects, process 1200 includes receiving recommendation information for the AI/ML model monitoring operation, where the one or more criteria are based on the recommendation information.

In a twelfth aspect, alone or in combination with one or more of the first through eleventh aspects, process 1200 includes receiving a capability report indicating one or more capabilities for the AI/ML model monitoring operation, where the one or more criteria are based on the one or more capabilities.

In a thirteenth aspect, alone or in combination with one or more of the first through twelfth aspects, process 1200 includes refraining from modifying, during a monitoring time of the AI/ML model monitoring operation at the second network entity, one or more operating conditions for the second network entity.

In a fourteenth aspect, alone or in combination with one or more of the first through thirteenth aspects, the one or more operating conditions include at least one of a scheduling scheme, or a beam codebook.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a network entity, or a network entity may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 114 described in connection with FIG. 1 and/or the communication manager 240 described in connection with FIG. 2. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 7-10. Additionally, or alternatively, the apparatus 1300 may be configured to perform one or more processes described herein, such as process 1100 of FIG. 11, or a combination thereof. In some aspects, the apparatus 1300 and/or one or more components shown in FIG. 13 may include one or more components of the UE or network node described in connection with FIG. 3. Additionally, or alternatively, one or more components shown in FIG. 13 may be implemented within one or more components described in connection with FIG. 3. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, one or more modems, one or more demodulators, one or more MIMO detectors, one or more receive processors, one or more controllers/processors, one or more memories, or a combination thereof, of the UE or network node described in connection with FIG. 3.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, one or more modems, one or more modulators, one or more transmit MIMO processors, one or more transmit processors, one or more controllers/processors, one or more memories, or a combination thereof, of the UE or network node described in connection with FIG. 3. In some aspects, the transmission component 1304 may be co-located with the reception component 1302 in one or more transceivers.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The reception component 1302 may receive one or more criteria for an AI/ML model monitoring operation. The communication manager 1306 may perform, for an AI/ML model, the AI/ML model monitoring operation based on a first distribution of inference data associated with the AI/ML model satisfying the one or more criteria. The communication manager 1306 may perform, for the AI/ML model, an action based on the AI/ML model monitoring operation.

The transmission component 1304 may transmit information associated with the one or more condition parameters, wherein the one or more criteria are based on the information.

The transmission component 1304 may transmit recommendation information for the AI/ML model monitoring operation, wherein the one or more criteria are based on the recommendation information.

The transmission component 1304 may transmit a capability report indicating one or more capabilities for the AI/ML model monitoring operation, wherein the one or more criteria are based on the one or more capabilities.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a network entity, or a network entity may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 118 described in connection with FIG. 1 and/or the communication manager 250 described in connection with FIG. 2. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIGS. 7-10. Additionally, or alternatively, the apparatus 1400 may be configured to perform one or more processes described herein, such as process 1200 of FIG. 12, or a combination thereof. In some aspects, the apparatus 1400 and/or one or more components shown in FIG. 14 may include one or more components of the UE or network node described in connection with FIG. 3. Additionally, or alternatively, one or more components shown in FIG. 14 may be implemented within one or more components described in connection with FIG. 3. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, one or more modems, one or more demodulators, one or more MIMO detectors, one or more receive processors, one or more controllers/processors, one or more memories, or a combination thereof, of the UE or network node described in connection with FIG. 3.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, one or more modems, one or more modulators, one or more transmit MIMO processors, one or more transmit processors, one or more controllers/processors, one or more memories, or a combination thereof, of the UE or network node described in connection with FIG. 3. In some aspects, the transmission component 1404 may be co-located with the reception component 1402 in one or more transceivers.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The transmission component 1404 may transmit, for a second network entity, one or more criteria for inference data to be used for an AI/ML model monitoring operation for an AI/ML model deployed at the second network entity.

The reception component 1402 may receive information associated with the one or more condition parameters, wherein the one or more criteria are based on the information.

The reception component 1402 may receive recommendation information for the AI/ML model monitoring operation, wherein the one or more criteria are based on the recommendation information.

The reception component 1402 may receive a capability report indicating one or more capabilities for the AI/ML model monitoring operation, wherein the one or more criteria are based on the one or more capabilities.

The communication manager 1406 may refrain from modifying, during a monitoring time of the AI/ML model monitoring operation at the second network entity, one or more operating conditions for the second network entity.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a network entity, comprising: receiving one or more criteria for an artificial intelligence or machine learning (AI/ML) model monitoring operation; performing, for an AI/ML model, the AI/ML model monitoring operation based on a first distribution of inference data associated with the AI/ML model satisfying the one or more criteria; and performing, for the AI/ML model, an action based on the AI/ML model monitoring operation.

Aspect 2: The method of Aspect 1, wherein performing the AI/ML model monitoring operation comprises: comparing, for the AI/ML model, the first distribution to a second distribution of training data associated with the AI/ML model based on the first distribution satisfying the one or more criteria.

Aspect 3: The method of any of Aspects 1-2, wherein the one or more criteria include timing information associated with the first distribution.

Aspect 4: The method of Aspect 3, wherein the timing information includes an amount of time, and wherein performing the AI/ML model monitoring operation comprises: performing the AI/ML model monitoring operation using data, from the inference data, that is collected after the amount of time from a monitoring time.

Aspect 5: The method of any of Aspects 3-4, wherein the timing information includes a time window, and wherein performing the AI/ML model monitoring operation comprises: performing the AI/ML model monitoring operation using data, from the inference data, that is collected during the time window.

Aspect 6: The method of any of Aspects 3-5, wherein the timing information includes a first amount of time and a second amount of time, and wherein performing the AI/ML model monitoring operation comprises: performing the AI/ML model monitoring operation using data, from the inference data, that is collected after the first amount of time from a monitoring time, and wherein the data is collected at least the second amount of time from the monitoring time.

Aspect 7: The method of any of Aspects 1-6, wherein the one or more criteria include a quantity of measurement samples to be included in the inference data.

Aspect 8: The method of Aspect 7, wherein performing the AI/ML model monitoring operation comprises: performing the AI/ML model monitoring operation using data, from the inference data, that includes at least the quantity of measurement samples.

Aspect 9: The method of any of Aspects 1-8, wherein the one or more criteria include an allowable time gap between measurement samples to be included in the inference data.

Aspect 10: The method of Aspect 9, wherein performing the AI/ML model monitoring operation comprises: performing the AI/ML model monitoring operation based on the inference data including measurement samples having respective time gaps that are less than or equal to the allowable time gap.

Aspect 11: The method of any of Aspects 1-10, wherein the AI/ML model is configured to perform a function, and wherein the one or more criteria include at least one criterion that is associated with the function.

Aspect 12: The method of any of Aspects 1-11, wherein the one or more criteria are associated with one or more condition parameters, and wherein performing the AI/ML model monitoring operation comprises: detecting the one or more condition parameters; and applying the one or more criteria to the performance of the AI/ML model monitoring operation based on the detection of the one or more condition parameters.

Aspect 13: The method of Aspect 12, wherein the one or more condition parameters include at least one of: a Doppler parameter, a speed parameter, or a delay spread parameter.

Aspect 14: The method of any of Aspects 12-13, further comprising: transmitting information associated with the one or more condition parameters, wherein the one or more criteria are based on the information.

Aspect 15: The method of any of Aspects 1-14, wherein performing the AI/ML model monitoring operation comprises: comparing, for the AI/ML model, the first distribution to a second distribution of training data associated with the AI/ML model; and determining, based on the comparison, a similarity metric indicating a similarity of the first distribution and the second distribution.

Aspect 16: The method of Aspect 15, wherein performing the action comprises: performing the action based on whether the similarity metric satisfies a threshold.

Aspect 17: The method of Aspect 16, wherein the threshold is based on a quantity of measurement samples included in the inference data.

Aspect 18: The method of any of Aspects 1-17, further comprising: transmitting recommendation information for the AI/ML model monitoring operation, wherein the one or more criteria are based on the recommendation information.

Aspect 19: The method of any of Aspects 1-18, further comprising: transmitting a capability report indicating one or more capabilities for the AI/ML model monitoring operation, wherein the one or more criteria are based on the one or more capabilities.

Aspect 20: The method of any of Aspects 1-19, wherein performing the action comprises: performing one or more AI/ML operations using the AI/ML model.

Aspect 21: The method of any of Aspects 1-20, wherein the AI/ML model is a first AI/ML model, and wherein the processing system, to perform the action, is configured to: switching the AI/ML model to a second AI/ML model.

Aspect 22: The method of any of Aspects 1-21, wherein performing the action comprises: performing, for the AI/ML model, one or more training operations.

Aspect 23: The method of any of Aspects 1-22, wherein the AI/ML model is associated with a function, and wherein performing the action comprises: performing the function via a non-AI/ML operation.

Aspect 24: A method of wireless communication performed by a first network entity, comprising: transmitting, for a second network entity, one or more criteria for inference data to be used for an artificial intelligence or machine learning (AI/ML) model monitoring operation for an AI/ML model deployed at the second network entity.

Aspect 25: The method of Aspect 24, wherein the one or more criteria include timing information associated with the first distribution.

Aspect 26: The method of Aspect 25, wherein the timing information includes an amount of time during which the inference data is to be collected for the AI/ML model monitoring operation.

Aspect 27: The method of any of Aspects 25-26, wherein the timing information includes a time window during which the inference data is to be collected for the AI/ML model monitoring operation.

Aspect 28: The method of any of Aspects 25-27, wherein the timing information includes a first amount of time and a second amount of time for a collection of the inference data for the AI/ML model monitoring operation.

Aspect 29: The method of any of Aspects 24-28, wherein the one or more criteria include a quantity of measurement samples to be included in the inference data.

Aspect 30: The method of any of Aspects 24-29, wherein the one or more criteria include an allowable time gap between measurement samples to be included in the inference data.

Aspect 31: The method of any of Aspects 24-30, wherein the AI/ML model is configured to perform a function, and wherein the one or more criteria include at least one criterion that is associated with the function.

Aspect 32: The method of any of Aspects 24-31, wherein the one or more criteria are associated with one or more condition parameters.

Aspect 33: The method of Aspect 32, wherein the one or more condition parameters include at least one of: a Doppler parameter, a speed parameter, or a delay spread parameter.

Aspect 34: The method of any of Aspects 32-33, further comprising: receiving information associated with the one or more condition parameters, wherein the one or more criteria are based on the information.

Aspect 35: The method of any of Aspects 24-34, further comprising: receiving recommendation information for the AI/ML model monitoring operation, wherein the one or more criteria are based on the recommendation information.

Aspect 36: The method of any of Aspects 24-35, further comprising: receiving a capability report indicating one or more capabilities for the AI/ML model monitoring operation, wherein the one or more criteria are based on the one or more capabilities.

Aspect 37: The method of any of Aspects 24-36, further comprising: refraining from modifying, during a monitoring time of the AI/ML model monitoring operation at the second network entity, one or more operating conditions for the second network entity.

Aspect 38: The method of Aspect 37, wherein the one or more operating conditions include at least one of: a scheduling scheme, or a beam codebook.

Aspect 39: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-38.

Aspect 40: An apparatus for wireless communication at a device, the apparatus comprising one or more memories and one or more processors coupled to the one or more memories, the one or more processors configured to cause the device to perform the method of one or more of Aspects 1-38.

Aspect 41: An apparatus for wireless communication, the apparatus comprising at least one means for performing the method of one or more of Aspects 1-38.

Aspect 42: A non-transitory computer-readable medium storing code for wireless communication, the code comprising instructions executable by one or more processors to perform the method of one or more of Aspects 1-38.

Aspect 43: A non-transitory computer-readable medium storing a set of instructions for wireless communication, the set of instructions comprising one or more instructions that, when executed by one or more processors of a device, cause the device to perform the method of one or more of Aspects 1-38.

Aspect 44: A device for wireless communication, the device comprising a processing system that includes one or more processors and one or more memories coupled with the one or more processors, the processing system configured to cause the device to perform the method of one or more of Aspects 1-38.

Aspect 45: An apparatus for wireless communication at a device, the apparatus comprising one or more memories and one or more processors coupled to the one or more memories, the one or more processors individually or collectively configured to cause the device to perform the method of one or more of Aspects 1-38.

The foregoing disclosure provides illustration and description but is neither exhaustive nor limiting of the scope of this disclosure. For example, various aspects and examples are disclosed herein, but this disclosure is not limited to the precise form in which such aspects and examples are described. Modifications and variations may be made in light of the above disclosure or may be acquired from practice of the aspects.

As used herein, the term “component” shall be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. Systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, and/or measuring, among other examples. Also, “determining” can include receiving (such as receiving information), accessing (such as accessing data stored in memory), and/or transmitting (such as transmitting information), among other examples. As another example, “determining” can include resolving, selecting, obtaining, choosing, establishing, and/or other such similar actions.

Even though particular combinations of features are recited in the claims and/or disclosed in the specification, these combinations do not limit the scope of the disclosure. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As used herein, a phrase referring to “at least one of” a list of items refers to any combination of those items, including single members. As an example, “at least one of: a, b, or c” covers a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” include one or more items and may be used interchangeably with “one or more.” Further, as used herein, the article “the” may include one or more items referenced in connection with the article “the” and may be used interchangeably with “the one or more.” Furthermore, as used herein, the terms “set” and “group” may include one or more items and may be used interchangeably with “one or more.” Where only one item is intended, the phrase “only one” or similar language is used. Also, as used herein, the terms “has,” “have,” “having,” and similar terms are open-ended terms that do not limit an element that they modify (for example, an element “having” A may also have B). Further, the phrase “based on” means “based on or otherwise in association with” unless explicitly stated otherwise. Also, as used herein, the term “or” is inclusive when used in a series and may be used interchangeably with “and/or,” unless explicitly stated otherwise (for example, if used in combination with “either” or “only one of”). Further, “one or more” may be equivalent to “at least one.”

Even though particular combinations of features are recited in the claims or disclosed in the specification, these combinations are not limiting of the disclosure of various aspects. Many of these features may be combined in ways not specifically recited in the claims or disclosed in the specification. The disclosure of various aspects includes each dependent claim in combination with every other claim in the claim set.

What is claimed is:

1. A network entity for wireless communication, comprising:
a processing system configured to:
receive one or more criteria for an artificial intelligence or machine learning (AI/ML) model monitoring operation;
perform, for an AI/ML model, the AI/ML model monitoring operation based on a first distribution of inference data associated with the AI/ML model satisfying the one or more criteria; and
perform, for the AI/ML model, an action based on the AI/ML model monitoring operation.

2. The network entity of claim 1, wherein the processing system, to perform the AI/ML model monitoring operation, is configured to:
compare, for the AI/ML model, the first distribution to a second distribution of training data associated with the AI/ML model based on the first distribution satisfying the one or more criteria.

3. The network entity of claim 1, wherein the one or more criteria include timing information associated with the first distribution.

4. The network entity of claim 3, wherein the timing information includes an amount of time, and wherein the processing system, to perform the AI/ML model monitoring operation, is configured to:
perform the AI/ML model monitoring operation using data, from the inference data, that is collected after the amount of time from a monitoring time.

5. The network entity of claim 3, wherein the timing information includes a first amount of time and a second amount of time, and wherein the processing system, to perform the AI/ML model monitoring operation, is configured to:
perform the AI/ML model monitoring operation using data, from the inference data, that is collected after the first amount of time from a monitoring time, and wherein the data is collected at least the second amount of time from the monitoring time.

6. The network entity of claim 1, wherein the one or more criteria include a quantity of measurement samples to be included in the inference data.

7. The network entity of claim 1, wherein the one or more criteria include an allowable time gap between measurement samples to be included in the inference data.

8. The network entity of claim 1, wherein the AI/ML model is configured to perform a function, and wherein the one or more criteria include at least one criterion that is associated with the function.

9. The network entity of claim 1, wherein the one or more criteria are associated with one or more condition parameters, and wherein the processing system, to perform the AI/ML model monitoring operation, is configured to:
detect the one or more condition parameters; and
apply the one or more criteria to the performance of the AI/ML model monitoring operation based on the detection of the one or more condition parameters.

10. The network entity of claim 1, wherein the processing system, to perform the AI/ML model monitoring operation, is configured to:
compare, for the AI/ML model, the first distribution to a second distribution of training data associated with the AI/ML model, the comparison being associated with a similarity of the first distribution and the second distribution.

11. The network entity of claim 10, wherein the processing system, to perform the action, is configured to:
perform the action based on whether the similarity metric satisfies a threshold, wherein the threshold is based on a quantity of measurement samples included in the inference data.

12. A method of wireless communication performed by a network entity, comprising:
receiving one or more criteria for an artificial intelligence or machine learning (AI/ML) model monitoring operation;
performing, for an AI/ML model, the AI/ML model monitoring operation based on a first distribution of inference data associated with the AI/ML model satisfying the one or more criteria; and
performing, for the AI/ML model, an action based on the AI/ML model monitoring operation.

13. The method of claim 12, wherein the one or more criteria include timing information associated with the first distribution.

14. The method of claim 12, wherein the one or more criteria include a quantity of measurement samples to be included in the inference data.

15. The method of claim 12, wherein the one or more criteria include an allowable time gap between measurement samples to be included in the inference data, and wherein performing the AI/ML model monitoring operation comprises:
performing the AI/ML model monitoring operation based on the inference data including measurement samples having respective time gaps that are less than or equal to the allowable time gap.

16. The method of claim 12, further comprising:
transmitting recommendation information for the AI/ML model monitoring operation, wherein the one or more criteria are based on the recommendation information.

17. The method of claim 12, further comprising:
transmitting a capability report indicating one or more capabilities for the AI/ML model monitoring operation, wherein the one or more criteria are based on the one or more capabilities.

18. A non-transitory computer-readable medium having instructions for wireless communication stored thereon that, when executed by a network entity, causes the network entity to:
receive one or more criteria for an artificial intelligence or machine learning (AI/ML) model monitoring operation;
perform, for an AI/ML model, the AI/ML model monitoring operation based on a first distribution of inference data associated with the AI/ML model satisfying the one or more criteria; and
perform, for the AI/ML model, an action based on the AI/ML model monitoring operation.

19. The non-transitory computer-readable medium of claim 18, wherein the one or more criteria include timing information associated with the first distribution.

20. The non-transitory computer-readable medium of claim 18, wherein the one or more criteria include a quantity of measurement samples to be included in the inference data.
